(19) United States
(12) Patent Application Publication
(10) Pub. No.: US 2009/0230013 A1
(43) Pub. Date: Sep. 17, 2009

(54) User-Customizable Dosing System

(75) Inventors: Jason Alan Born, Loveland, OH (US); Deborah M. Doan, Mason, OH (US); Susan Elaine Criss, Maineville, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/405,438

(22) Filed: Mar. 17, 2009

Related U.S. Application Data
(60) Provisional application No. 61/069,723, filed on Mar. 17, 2008.

(51) Int. Cl. A61J 1/14; B65D 83/04

(52) U.S. Cl. 206/531; 206/534

(57) ABSTRACT

A customizable dosing system is provided, comprising a primary container comprising at least one enclosure, the enclosure containing a dosage unit comprising an active; indicia for selection or deselection of one or more of the dosage units and actives; wherein the indicia enables a user to select a system and one or more dosage units and actives appropriate to a user's needs. Also provided are methods of customizing dosage and treatment, and kits containing a customizable dosing system and one or more complimentary products.

### CROSS REFERENCE TO RELATED APPLICATION

This reference claims the benefit of U.S. Provisional Application No. 61/069723, filed on Mar. 17, 2008.

### FIELD OF THE INVENTION

The present invention relates to a dosing system that allows a user to select and customize dosing of one or more actives. More particularly, the invention also relates to methods of enabling a user to select and customize an appropriate dosing system of one or more dosage units, and also includes kits comprising the dosing system.

### BACKGROUND OF THE INVENTION

As consumers have become more educated and involved in the treatment of their bodies, there has arisen a desire to selectively administer actives appropriate to the symptoms a user exhibits, and/or to the benefits a user wishes to achieve. However, many products provide only combination actives containing multiple actives, some of which may be unnecessary and/or undesired by a user. Other products provide only single actives which must be purchased separately.

For example, respiratory conditions encompass a broad range of ailments, including viral infections such as cold and flu, bacterial infections, as well as allergies, sinusitis, rhinitis, and the like. Respiratory conditions may present with any or all of a variety of symptoms, such as runny nose, nasal and/or chest congestion, cough, sneezing, pressure, headache, aches, fever and/or sore throat. Most respiratory products are available as either multi-symptom products which contain combinations of actives to treat all or most common respiratory symptoms, or are available as separate, discrete, single-symptom products. Thus, a user is faced with purchasing and administering a product that may contain more actives than necessary or desired, or separately purchasing a product for each symptom. Many users do not wish to administer an active for a symptom not present. However, purchasing separate products for every symptom can become costly, and can result in multiple, partially used products retained in the home, one or more of which is often expired by the time the user next needs one or more such products.

The same types of disadvantages are present for gastrointestinal conditions and products, as well as for products related to enhancing overall well-being. For example, one must make the choice of purchasing a separate antacid, laxative and/or anti-nausea product, or a combination product. One must also purchase a multi-vitamin, or separate containers of a variety of vitamins or other actives desired by a user for wellness.

Users therefore commonly either administer actives they don't necessarily need or want in order to obtain a particular desired relief or benefit, or they must purchase separate products for every symptom or desired benefit.

Thus, there is a need for a customizable dosage system that provides users with a variety of dosage units and actives that can be administered in any combination as desired by the user. In addition, there is also a need for providing indicia to instruct a user as to what dosing system and dosing unit is appropriate to treat a particular symptom or symptoms and/or to provide a particular benefit or benefits and to guide users in selection of appropriate systems.

### SUMMARY OF THE INVENTION

The present invention comprises a customizable dosing system comprising a primary container comprising at least one enclosure, the enclosure containing a dosage unit comprising an active; and indicia for selection or deselection of an appropriate dosing system and one or more dosage units and actives; wherein the indicia enables a user to select an appropriate dosing system and one or more dosage units and actives appropriate to a user's needs. The system can also include a secondary container that contains the primary container and indicia.

The present invention also includes methods of customizing treatment comprising providing a primary container comprising at least one enclosure, the enclosure containing a dosage unit comprising an active; providing indicia for selection or deselection of an appropriate dosing system and one or more dosage units and actives; enabling a user to select an appropriate dosing system, dosing unit and active appropriate to a user's needs.

The present invention also includes kits for customizing treatment comprising: a primary container comprising at least one enclosure, the enclosure containing a dosage unit comprising an active; and indicia for selection or deselection of an appropriate dosing system and one or more dosage units and actives, as well as one or more products complimentary to the dosage units, actives and system.

The systems and kits of the present invention, and components thereof, can be provided in convenient, portable sizes and forms, such as would fit conveniently in a purse or pocket.

### BRIEF DESCRIPTION OF THE DRAWINGS

FIG. 1 is a perspective schematic view of a first embodiment of the invention.

FIG. 1A is a top plan view of a primary container of an embodiment of the invention.

FIG. 1B is a perspective view of a secondary container of the first embodiment of the invention.

FIG. 2 is a perspective schematic view of a second embodiment of the invention.

FIG. 2A is a perspective view of a secondary container of the second embodiment of the invention.

FIG. 3 is a perspective schematic view of a third embodiment of the invention.

FIG. 3A is a perspective view of a secondary container of the third embodiment of the invention.

FIG. 4 is a perspective schematic view of a fourth embodiment of the invention.

FIG. 4A is a top plan view of a primary container of the fourth embodiment of the invention.

FIG. 5 is a perspective schematic view of a fifth embodiment of the invention.

FIG. 5A is a top plan view of a primary container of the fifth embodiment of the invention.

FIG. 6 is a perspective schematic view of a sixth embodiment of the invention.

FIG. 6A is a top plan view of a primary container of the sixth embodiment of the invention.

FIG. 6B is a perspective view of a secondary container of the sixth embodiment of the invention.

FIG. 7 is a perspective schematic view of a seventh embodiment of the invention.

FIG. 7A is a perspective view of a secondary container of the seventh embodiment of the invention.

FIG. 8 is a perspective schematic view of an eighth embodiment of the invention.

FIG. 8A is a top plan view of a primary container of the eighth embodiment of the invention.

### DETAILED DESCRIPTION OF THE INVENTION

The present invention comprises a customizable dosing system comprising a primary container comprising at least one enclosure, the enclosure containing a dosage unit comprising an active; indicia for selection or deselection of an appropriate dosing system and one or more dosage units and actives; wherein the indicia enables a user to select an appropriate dosing system and one or more dosage units and actives appropriate to a user's needs. Such a system can be used to treat respiratory conditions, gastrointestinal conditions, and to preserve and maintain overall health and well-being, as desired by a user.

As used herein “active” includes all compounds and compositions that can be used to treat and/or prevent illness and/or provide overall health and well-ness benefits in mammals. Non-limiting examples of particularly useful actives include non-prescription and prescription actives, vitamins, minerals, elements, plant-derived materials, energy boosting materials, probiotics, fiber, prebiotics, and combinations thereof.

As used herein “indicia” provides information to a potential user or user of the systems, dosage units (i.e. the active contained therein) and kits of the present invention to enable a user to select an appropriate system, dosage unit and/or kit. The indicia can comprise many forms and present the information in many ways and in many types of media. Non-limiting examples of types of indicia include alpha-numeric indicia, pictures, drawings, illustrations, photographs, computer-produced images, colors, sounds, textures, shapes, symbols, letters, numbers, and combinations thereof. The indicia can be present in hard copy, tangible form; in machine-readable form, machine-generated generated form; and combinations thereof. Non-limiting examples of a machine include a computer, cellular telephone, personal digital assistant, and combinations thereof. Machine-readable and machine-generated forms include compact discs, hard discs, floppy discs, tape, magneto-optical discs, digital video discs, PROMs (i.e. EPROM, EEPROM, Flash EPROM), DRAM, SRAM, SDRAM, bar codes and combinations thereof. The machine-readable and machine-generated forms of indicia can also provide means for connecting to one or more other machines, i.e. computers and computer networks, via known data transmission lines and using known networks such as the Internet and or an Intranet. The means for connecting can enable a machine (used by a user) to receive data from other machines and/or networks via hard transmission lines and/or via wireless communication.

Indicia can be present on the primary container, secondary container, and/or dosage unit; can be provided in a separate form (i.e. paper insert) and contained within the secondary container; and can be printed, stamped, embossed, or embedded in or on the primary container, secondary container, dosage unit or as a separate form, using techniques that are known and understood in the printing and packaging fields. Indicia can also be present at the point of purchase to aid a user in deciding on an appropriate system to purchase.

All percentages, parts and ratios as used herein are by weight of the total composition of the dosage unit, unless otherwise specified. All such weights as they pertain to listed ingredients are based on the level of the active and, therefore, do not include solvents or by-products that may be included in commercial available materials or preparations, unless otherwise specified.

The systems, methods, and kits of the present invention can comprise, consist of, or consist essentially of, the essential elements and limitations of the invention described herein, as well as any additional or optional ingredients, components, or limitations described herein or otherwise useful in compositions intended for use by a mammal.

### Systems

Numerous embodiments of the customizable dosing system of the present invention are illustrated in the Figures below.

Generally, the systems of the present invention comprise a primary container, the primary container having at least one enclosure, the enclosure containing at least one dosage unit, the dosage unit comprising an active. The primary container can be a blister pack, blister card or blister sheet as would be understood and commonly used in the art. The primary container can be of varying shape and size as desired based upon the number, size and type of dosing units contained therein, and can be sized to be conveniently portable. Non-limiting examples of such shapes include round, oval, rectangular, square, triangular, trapezoidal, octagonal, and combinations thereof. The primary container can also be formed to have means to permit separation of one or more portions of the primary container, i.e. one or more portions containing an enclosure. As would be understood by those of skill in the art, non-limiting examples of such means include perforations, scoring and combinations thereof.

As would be understood by those skilled in the packaging arts, to include structure and making of packaging, a blister pack can include one or more blister layers and a rupturable layer, the combination of which encloses one or more dosage units. The blister layer provides enclosures, in any suitable size and/or shape, for one or more dosage units of any suitable size, shape or form. The rupturable layer permits the dosage unit to be removed from the blister pack. The rupturable layer can be formed over all or a portion of the blister layer. The rupturable layer can be affixed to the blister layer via the application of heat and pressure as is common in the art using conventional thermal forming methods, or by adhesive. Such blister packs can also comprise a backing layer that can be disposed on or over the rupturable layer to prevent unintended rupture and release of dosage units. Such backing layer can be peeled away to expose the rupturable layer when release of a dosage unit is desired. Such backing layer can be formed over all or a portion of the rupturable layer. Such a backing layer can be affixed to the rupturable layer and/or the blister layer via, for example, adhesive.

Blister layers can be made from a variety of suitable materials, non-limiting examples of which include polyvinyl chloride, thermoplastic materials, polyolefins and combinations thereof. The blister layer can be opaque, partially opaque, or transparent, and can be colorless or colored.

Rupturable layers can be made from a variety of suitable materials, non-limiting examples of which include metal foil, tempered metal foil, paperboard, polyvinyl chloride, polyolefins, polystyrenes, polyesters, fluoropolymer resins, and combinations thereof. The rupturable layer can also be formed as a laminate composed of a plurality of laminated layers of different materials, so long as its basic operation and rupturability is not affected. The rupturable layer can be of any desired color.

Backing layers can be made from a variety of suitable materials, non-limiting examples of which include paper, plastic, polyvinyl chloride, and combinations thereof. The backing layer can be of any desired color.

The systems of the present invention can also optionally include a secondary container. A secondary container can contain one or more separate, discrete primary containers and/or can be formed as an integrated structure with the primary container. The secondary container can be of varying shape, size and form as desired based upon the number, size and type of primary containers contained therein and/or formed as a part thereof, and can be sized to be conveniently portable. Non-limiting examples of such shapes and forms include round, oval, rectangular, square, triangular, trapezoidal, octagonal, foldable and combinations thereof. Non-limiting examples of secondary containers include boxes and cartons. Non-limiting examples of integrated primary and secondary containers include tri-fold structures in which a primary container is affixed to a secondary container that folds over one or more portions of the primary container; and structures shaped and structured similarly to a book in which one or more primary structures form page-like structures bound within a secondary container outer covering forming an integrated structure. The primary and secondary containers can also be separate, discrete elements, and one or more primary containers can be removed from the secondary container, for example to be carried and used throughout the course of a day. The secondary container can be made from a variety of materials, non-limiting examples of which include paper, paperboard, cardboard, plastic, and combinations thereof.

The secondary container can also provide one or more viewing apertures that can be an uncovered void in the secondary container or can be a void covered by a material, non-limiting examples of which include transparent plastic materials. The secondary container can also aid in the storage, transport, distribution, display, and/or sale of the primary container and the dosage units contained therein.

The secondary container can also comprise one or more digit-receiving portions to aid in handling of the primary and/or secondary container. Non-limiting examples of such digit-receiving portions include one or more indentations in the secondary container to allow access to and gripping of a primary container to permit removal of the primary container from the secondary container.

The primary container and/or the secondary container and/or the dosage units themselves can also comprise indicia, to enable a user to identify the appropriate system and appropriate dosage units and actives to select one or more systems, dosage units and actives appropriate to the user's needs.

The systems and dosage units of the present invention can contain actives for use with any of a variety of conditions and/or to achieve a variety of benefits, non-limiting examples of which include respiratory conditions, gastrointestinal conditions, respiratory health, gastrointestinal health, immune health, mobility and joint health, cardiovascular health, skin health, oral health, hair health, eye health, reproductive health, and combinations thereof.

The dosage units of the present invention can be of any form appropriate for oral and/or topical administration of respiratory, gastrointestinal and health and well-being actives, as described below and as would be understood by those of skill in the art. The dosage units can be arranged in the primary container(s) in any number of ways, depending on the system and the desired treatment and/or benefit.

A primary container can comprise multiple groups of dosage units arranged in multiple rows and/or columns of dosage units, each dosage unit being the same type of dosage unit, i.e. tablet, with each group of dosage units comprising a different active for treating particular symptoms or providing particular benefits.

As a non-limiting example, a system for treating a respiratory condition can comprise four rows of tablets, the tablets of each row containing a different active useful for treating a respiratory condition, arranged on a single primary container. The primary container and/or the dosage units can be provided with indicia to enable a user to identify the appropriate active(s) and use thereof. The primary container can be contained within a secondary container.

Alternatively, each group of dosage units can comprise a different type of dosage unit, i.e. tablet, dissolvable strip, lozenge, and liquid-filled capsule, each of which comprises a different active.

Alternatively, a primary container can comprise a single type of dosage unit, for example tablets, each containing the same single active. A plurality of primary containers can be provided, each primary container containing dosage units comprising a different active. As a non-limiting example, a system for treating a gastrointestinal condition can comprise four primary containers, each containing a different active for treating a gastrointestinal condition. The plurality of primary containers can be contained in a secondary container. The primary container, the dosage units and/or the secondary container can comprise indicia to enable a user to identify the appropriate system, appropriate active(s) and use thereof.

The present invention can also include kits that can comprise one or more systems of the present invention packaged in combination with complimentary products, as will be described below.

Particular embodiments of the present invention will now be described with reference to the Figures wherein like reference numerals refer to like elements throughout the drawings and wherein sub-element lettering corresponds to the number of the embodiment, i.e. the first embodiment contains no sub-element lettering, the second embodiment uses the letter “a”, the third embodiment uses the letter “b”, etc.

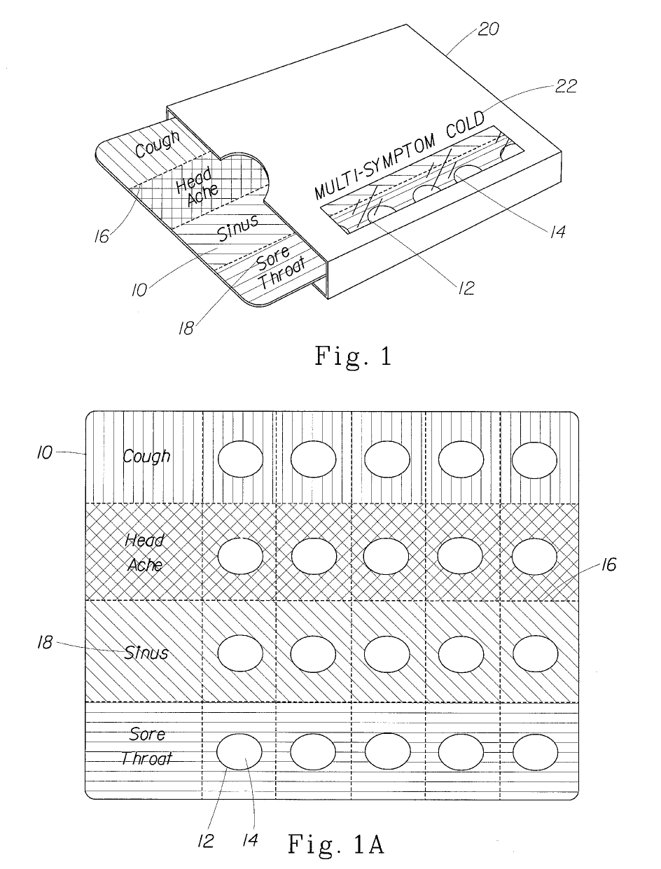

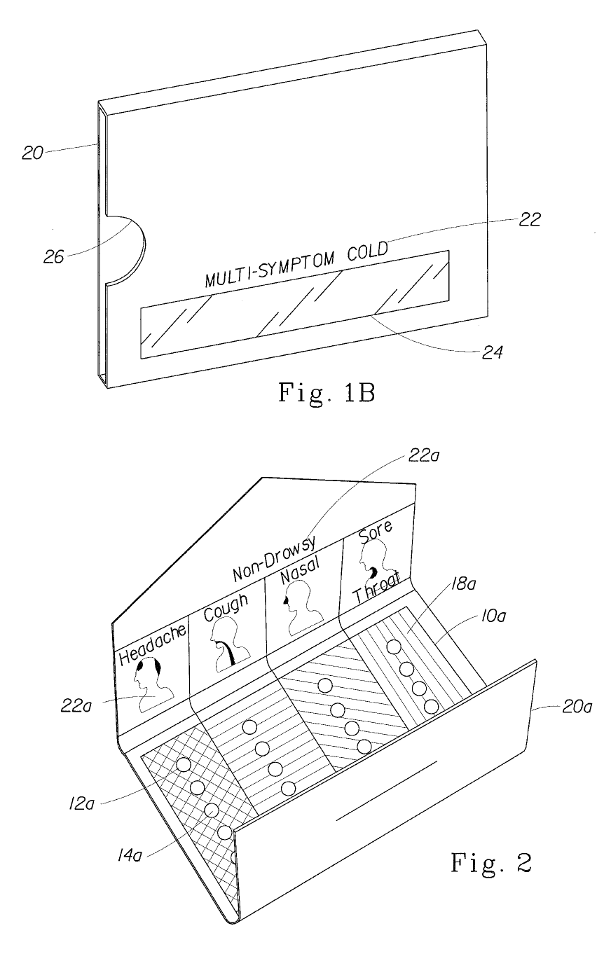

FIGS. 1, 1A and 1B illustrate an embodiment of the invention wherein the system comprises a primary container 10, the primary container 10 having a plurality of enclosures 12, each enclosure 12 containing a dosage unit 14. In this particular embodiment, primary container 10 is a blister card in a rectangular shape.

Primary container 10 also includes means 16 to allow portions of primary container to be separated and removed as desired. In this particular example, means 16 is a plurality of perforations.

Primary container 10 also comprises indicia 18 thereon, to enable a user to identify the dosage units and actives and to select one or more actives appropriate to the user's needs. In this embodiment, the indicia are text printed on primary container 10, and also include color.

As shown in FIG. 1 and particularly FIG. 1B, the system further includes a secondary container 20, which can contain primary container 10. In this embodiment secondary container 20 is a box or carton. In this embodiment, the secondary container 20 also includes indicia 22, to aid in directing a user to selection of an appropriate system. In this embodiment, the indicia are text. Secondary container 20 also comprises a viewing aperture 24 which permits viewing of a portion of primary container 10 therethrough. In addition, secondary container 20 also has an indentation 26 that can receive a digit of a user, to aid in removal of primary container 10 from secondary container 20.

FIGS. 2 and 2A illustrate another embodiment of the invention wherein the system comprises a primary container 10a, the primary container 10a having a plurality of enclosures 12a, each enclosure 12a containing a dosage unit 14a. In this embodiment, primary container 10a is a blister pack. The primary container 10a also comprises indicia 18a thereon, to enable a user to identify the dosage units and actives and select one or actives appropriate to the user's needs. In this embodiment, the indicia 18a are color. The system further includes a secondary container 20a, which can enclose primary container 10a. In this particular embodiment secondary container 20a is a foldable container. Secondary container 20a also includes indicia 22a, to aid in directing a user to the appropriate system. In this embodiment, the indicia 22a are pictorial and text. Secondary container 20a is foldable into a tri-fold arrangement to enclose primary container 10a. Primary container 10a is removable from secondary container 20a.

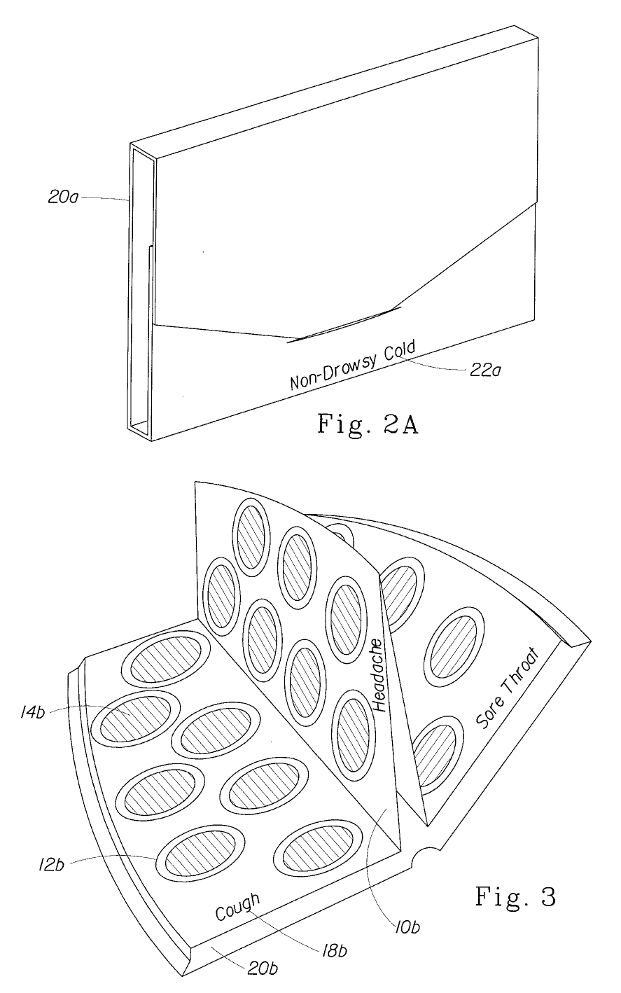

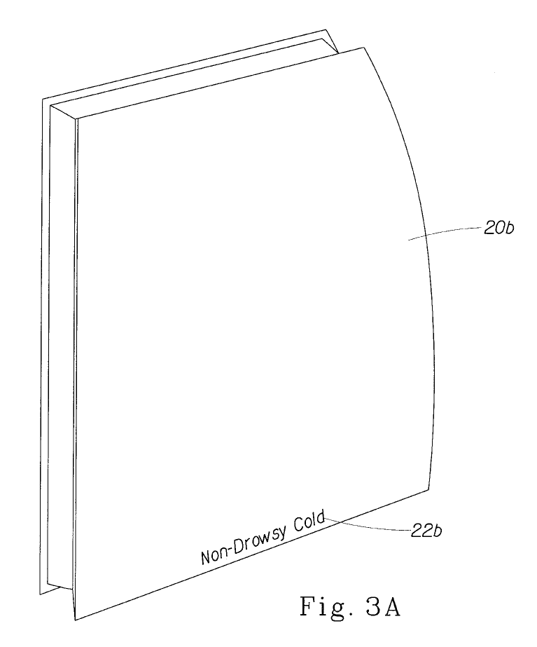

FIGS. 3 and 3A illustrate another embodiment of the invention wherein the system comprises a book-like structure. The system comprises a plurality of primary containers 10b, the primary containers 10b having a plurality of enclosures 12b, each enclosure 12b containing a dosage unit 14b. In this embodiment, each primary container 10b is a blister pack formed into the book-like structure. The primary container 10b also comprises indicia 18b thereon, to enable a user to identify the dosage units and actives and to select one or more actives appropriate to the user's needs. In this embodiment, the indicia 18b are text and also color of the dosage units 14b. The system further includes a secondary container 20b, which encloses the primary containers 10b. In this embodiment secondary container 20b is a foldable container that is book-like in shape and function, with primary containers 10b forming page-like structures within secondary container 20b. The secondary container 20b also includes indicia 22b, to aid in directing a user to the appropriate system. In this embodiment, the indicia 22b are text. Primary containers 10b are affixed to secondary container 20b.

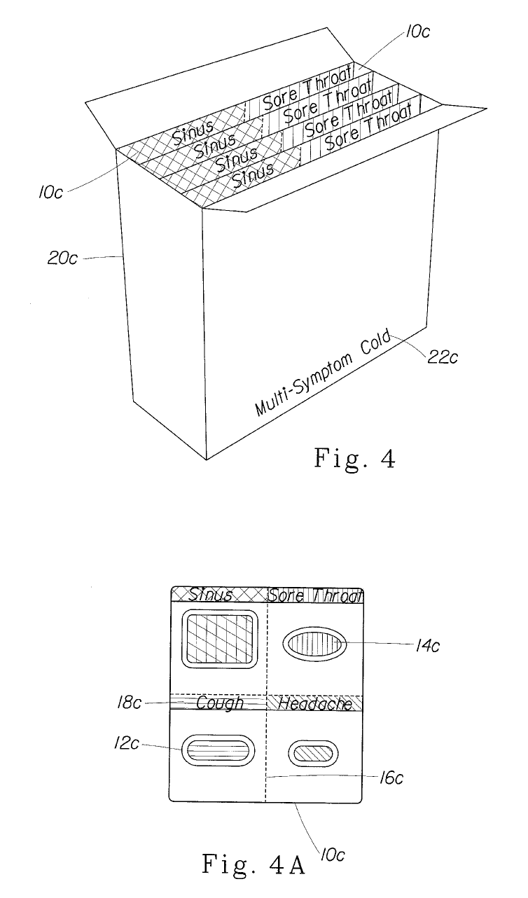

FIGS. 4 and 4A illustrate another embodiment of the invention wherein the system comprises multiple primary containers 10c, each primary container 10c having four enclosures 12c, each enclosure 12c containing a dosage unit 14c. In this particular embodiment, primary container 10c is a blister pack. The primary container 10c also comprises indicia 18c thereon, to enable a user to identify the dosage units and actives and to select one or more actives appropriate to the user's needs. In this embodiment, the indicia 18c are text and color on primary container 10c and dosage units 14c. In this embodiment, as shown particularly in FIG. 4A, primary container 10c contains four different types of dosage units 14c. In this particular embodiment, the top left enclosure contains a dissolvable strip, the top right enclosure contains a lozenge, the bottom left enclosure contains a gel cap and the bottom right enclosure contains a tablet. Each dosage form 14c can be a different size, shape and/or color as well. Each primary container 10c also comprises means 16c, in this embodiment a plurality of perforations, to allow portions of primary container 10c to be removed as desired. The system further includes a secondary container 20c, which encloses one or more primary containers 10c. In this embodiment secondary container 20c is a box with several primary containers 10c contained within secondary container 20c. Secondary container 20c also includes indicia 22c, to aid in directing a user to the appropriate system. In this embodiment, the indicia 22c are text. Primary containers 10c are removable from secondary container 20c and discardable when all the dosage units 14c therein have been used. A user can also remove one or more primary containers 10c to transport and use, for example, throughout the course of a day.

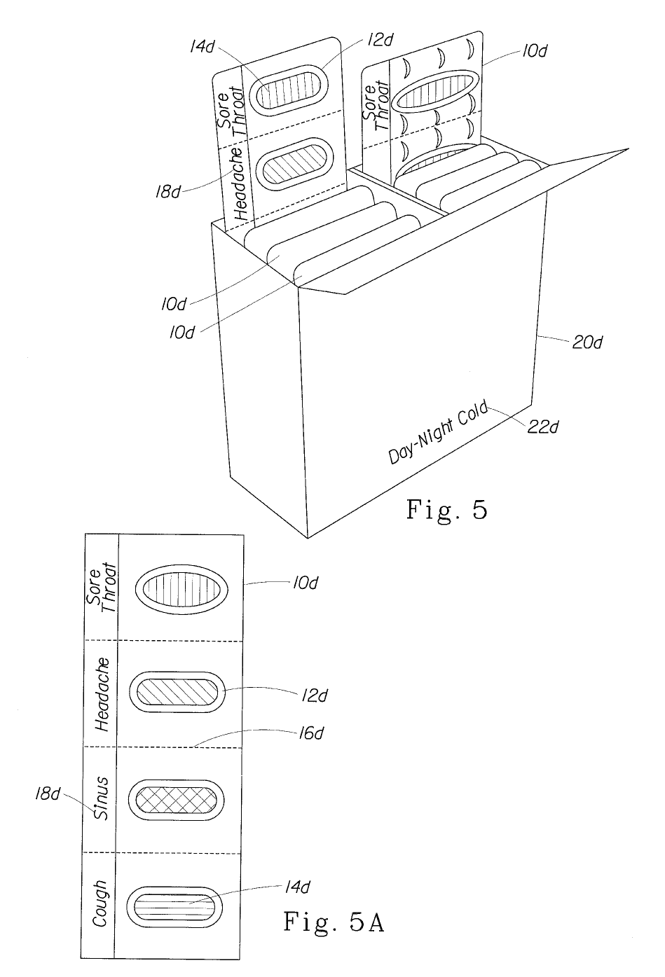

FIGS. 5 and 5A illustrate another embodiment of the invention wherein the system comprises multiple primary containers 10d, each primary container 10d having four enclosures 12d, each enclosure 12d containing a dosage unit 14d. In this embodiment, primary container 10d is a blister pack. The primary container 10d also comprises indicia 18d thereon, to enable a user to identify the dosage units and actives and to select one or more actives appropriate to the user's needs. In this embodiment, the indicia 18d are text and color. Each primary container 10d also comprises means 16d, in this embodiment a plurality of perforations, to allow portions of primary container to be removed as desired. The system further includes a secondary container 20d, which contains primary containers 10d. In this embodiment secondary container 20d is a box with several primary containers 10d containable within secondary container 20d. Secondary container 20d also includes indicia 22d, to aid in directing a user to the appropriate system. In this embodiment, the indicia 22d are text. Primary containers 10d are removable from secondary container 20d and discardable when all the dosage units 14d therein have been used. A user can also remove one or more primary containers 10d to transport and use, for example, throughout the course of a day.

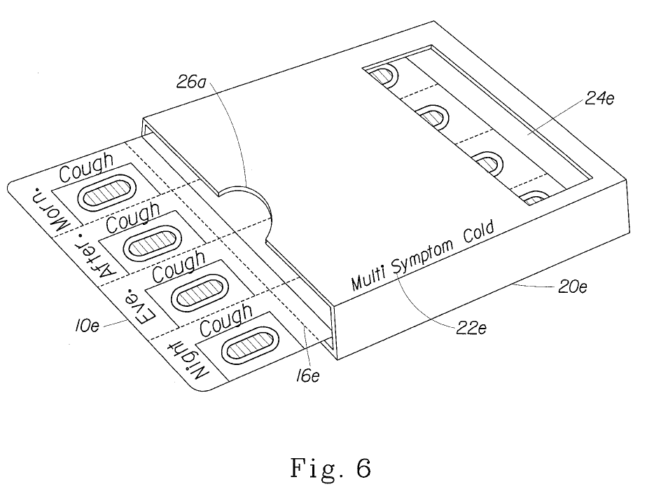

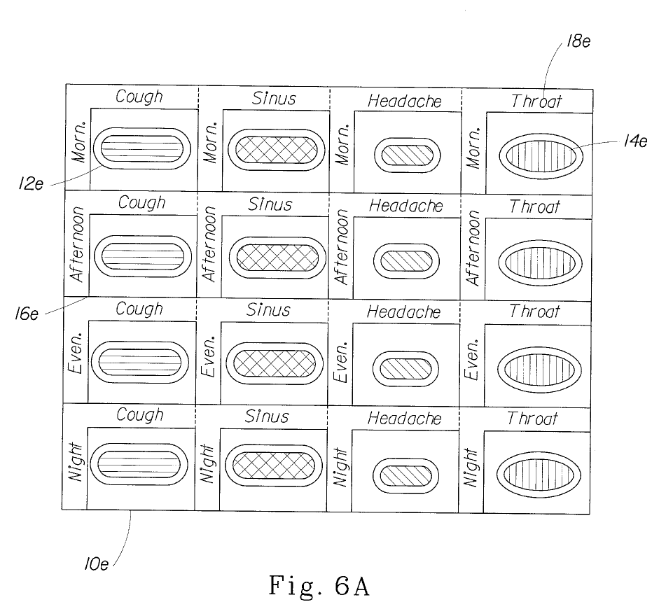

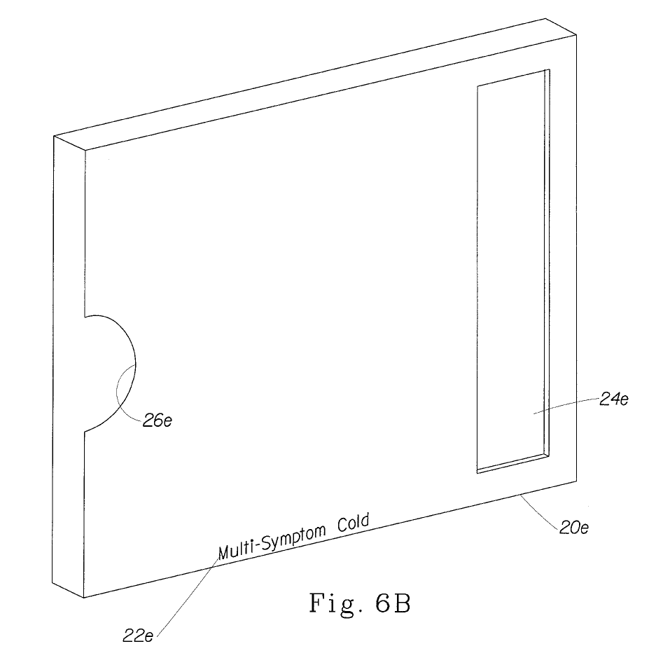

FIGS. 6, 6A and 6B illustrate an embodiment of the invention wherein the system comprises a primary container 10e, the primary container 10e having a plurality of enclosures 12e, each enclosure 12e containing a dosage unit 14e. In this embodiment, primary container 10e is a blister pack. Primary container 10e also includes means 16e, in this embodiment a plurality of perforations, to allow portions of primary container 10e to be removed as desired. Primary container 10e also comprises indicia 18e thereon, to enable a user to identify the dosage units and actives and to select one or more actives appropriate to the user's needs. In this embodiment, the indicia 18e are text printed on primary container 10e, and also include color. As shown in FIG. 6 and particularly FIG. 6B, the system further includes a secondary container 20e, which encloses primary container 10e. In this embodiment secondary container 20e is a box or carton. In this embodiment, the secondary container 20e also includes indicia 22e, to aid in directing a user to appropriate use of the appropriate system. In this embodiment, the indicia 22e are text. Secondary container 20e also comprises a viewing aperture 24e which permits viewing of a portion of primary container 10e therethrough. In addition, secondary container 20e also has an indentation 26e that can accept a digit of a user, to aid in removal of primary container 10e from secondary container 20e.

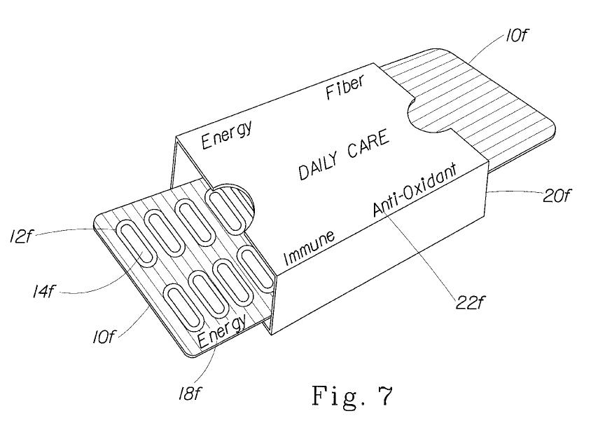

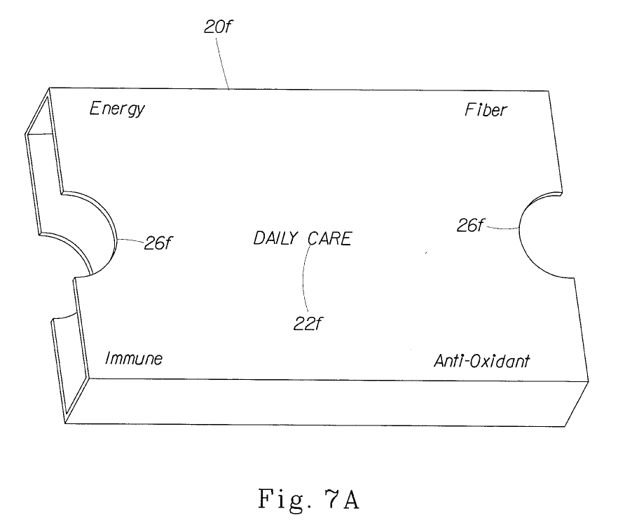

FIGS. 7 and 7A illustrate an embodiment of the invention wherein the system comprises multiple primary containers 10f, primary containers 10f having a plurality of enclosures 12f, each enclosure 12f containing a dosage unit 14f. In this embodiment, primary container 10f is a blister pack. In this embodiment two primary containers 10f are shown. Primary container 10f also comprises indicia 18f thereon, to enable a user to identify the dosage units and actives and to select one or more actives appropriate to the user's needs. In this embodiment, the indicia 18f are text printed on primary container 10f and also include color. The system further includes a secondary container 20f, which encloses primary containers 10f. In this embodiment secondary container 20f is a box or carton. In this embodiment, the secondary container 20f also includes indicia 22f, to aid in directing a user to appropriate use of the appropriate system. In this embodiment, the indicia 22f are text. In this embodiment, secondary container 20f has two indentations 26f that can accept a digit of a user, to aid in removal of primary containers 10f from secondary container 20f.

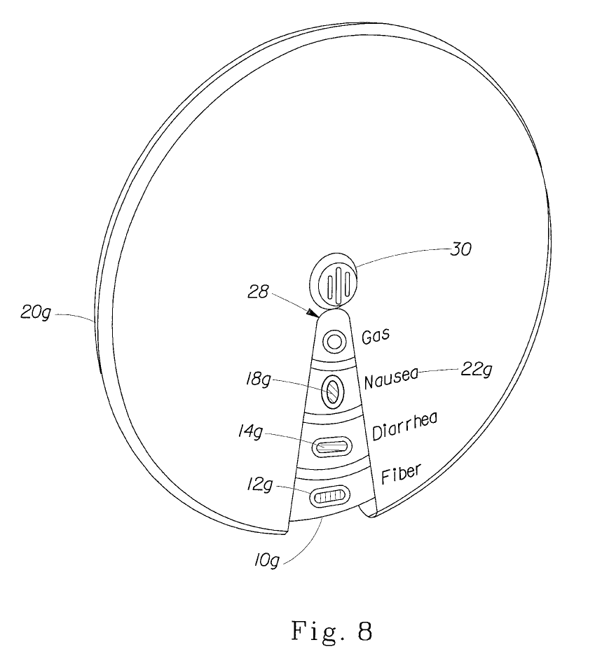

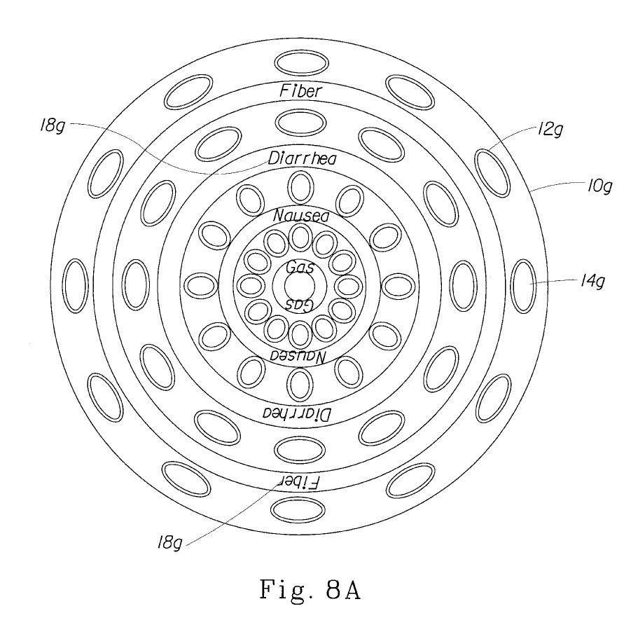

FIG. 8 illustrates an embodiment of the invention wherein the system comprises a primary container 10g, the primary container 10g having a plurality of enclosures 12g, each enclosure 12g containing a dosage unit 14g. In this embodiment, primary container 10g is a blister pack in a circular shape. Primary container contains four different types of dosage units 14g each of different form and shape. Primary container 10g also comprises indicia 18g thereon, to enable a user to identify the dosage units and actives and to select one or more actives appropriate to the user's needs. In this embodiment, the indicia 18g are that the types of dosage units 14g are differently colored. The system further includes a secondary container 20g, which encloses primary container 10g. In this embodiment secondary container 20g is a round container. In this embodiment, the secondary container 20g also includes indicia 22g, to aid in directing a user to appropriate use of the appropriate system. In this embodiment, the indicia 22g are text. Secondary container 20g also comprises, in this embodiment, a wedge-shaped viewing aperture 28 which permits viewing of a portion of primary container 10g therethrough. In addition, secondary container 20g also has a dialing means 30 which is manipulable by a user to rotate primary container 10g within secondary container 20g. FIG. 8A illustrates an alternate embodiment of primary container 10g in which indicia 18g are text applied to primary container 10g.

### Compositions

The actives of the present invention can be selected from the following non-limiting list of actives: non-prescription pharmaceutical actives, prescription pharmaceutical actives, vitamins, minerals, elements, plant-derived materials, energy-boosting materials, probiotics, fiber, prebiotics, and combinations thereof. Such actives are grouped generally below for ease of presentation, but as would be understood by those of skill in the art, there is overlap in usage of many of the actives described herein—for example such actives as anti-inflammatory and/or pain actives which can be used with respiratory conditions, gastrointestinal conditions, muscle and joint conditions, menstrual conditions and the like. When used in the systems, methods and kits of the present invention, prescription actives can be administered according to a prescribed regimen and can be combined in a system or kit with additional, non-prescription actives.

### Respiratory

The dosage units and systems of the present invention can comprise one or more actives useful to treat a respiratory condition. Respiratory conditions encompass a broad range of conditions, including viral infections such as cold and flu, bacterial infections, as well as allergies, sinusitis, rhinitis, and the like. Respiratory conditions may present with any of a variety of symptoms, such as runny nose, nasal and/or chest congestion, cough, sneezing, pressure, headache, aches, fever, fatigue and/or sore throat. Actives typically used to treat these symptoms generally fall into the following classifications: decongestants, anti-cholinergics, expectorants, antihistamines, antitussives, analgesics, anti-virals, mucolytics, demulcents, anesthetics, and antibiotics. Such actives can include non-prescription pharmaceutical actives and prescription pharmaceutical actives.

Dosage units for treating respiratory symptoms associated with respiratory conditions can be manufactured in a number of product forms. Non-limiting examples of the most common include tablets, dragees, caplets, softgel capsules, solid-filled capsules, liquid-filled capsules, enteric-coated forms, sustained-release forms, solid lozenges, liquid-filled lozenges, mouth and throat drops, gums, confectionaries, “gummies”, effervescent tablets, dry dissolvable powders (for example in sachets or stick packs), dissolvable film strips, sublingual tablets, buccal tablets, syrups, elixirs and liquids for swallowing, treats, biscuits, patches for transdermal administration of an active, topical anti-microbial compositions, as well as inhalants and topical creams and lotions that release volatile agents that are inhaled through the nose into the respiratory tract, and combinations thereof Oral compositions are typically swallowed immediately, or slowly dissolved in the mouth.

Such dosage units can be prepared by any known or otherwise effective technique as would be understood by those of skill in the art.

Non-limiting examples of non-prescription pharmaceutical actives and prescription pharmaceutical actives suitable for use with respiratory conditions include:

decongestants, non-limiting examples of which include pseudoephedrine, phenylephrine, phenylpropanolamine, oxymetazoline, xylometazoline, naphazoline, 1-desoxyephedrine, ephedrine, propylhexedrine, and combinations thereof;

anticholinergics, non-limiting examples of which include ipratropium, chlorpheniramine, brompheniramine, diphenhydramine, doxylamine, clemastine, triprolidine, and combinations thereof;

expectorants, non-limiting examples of which include guaifenesin, ambroxol, bromhexine, and combinations thereof;

antihistamines, non-limiting examples of which include chlorpheniramine, diphenhydramine, doxylamine, triprolidine, clemastine, pheniramine, brompheniramine, dexbrompheniramine, loratadine, cetirizine and fexofenadine, amlexanox, alkylamine derivatives, cromolyn, acrivastine, ibudilast, bamipine, ketotifen, nedocromil, omalizumab, dimethindene, oxatomide, pemirolast, pyrrobutamine, pentigetide, thenaldine, picumast, tolpropamine, ramatroban, repirinast, suplatast tosylate aminoalkylethers, tazanolast, bromodiphenhydramine, tranilast, carbinoxamine, traxanox, chlorphenoxamine, diphenylpyaline, embramine, p-methyldiphenhydramine, moxastine, orphenadrine, phenyltoloxamine, setastine, ethylenediamine derivatives, chloropyramine, chlorothen, methapyrilene, pyrilamine, talastine, thenyldiamine, thonzylamine hydrochloride, tripelennamine, piperazines, chlorcyclizine, clocinizine, homochlorcyclizine, hydroxyzine, tricyclics, phenothiazines, mequitazine, promethazine, thiazinamium methylsulfate, azatadine, cyproheptadine, deptropine, desloratadine, isothipendyl, olopatadine, rupatadine, antazoline, astemizole, azelastine, bepotastine, clemizole, ebastine, emedastine, epinastine, levocabastine, mebhydroline, mizolastine, phenindamine, terfenadine, tritoqualine, and combinations thereof.

anti-tussives (cough suppressants), non-limiting examples of which include dextromethorphan, menthol, codeine, chlophedianol, levodropropizine, and combinations thereof;

analgesics, anti-inflammatories and antipyretics, non-limiting examples of which include acetaminophen, ibuprofen, ketoprofen, diclofenac, naproxen, aspirin, and combinations thereof, as well as prescription analgesics, non-limiting examples of which include propyxhene HCl, codeine, mepridine, and combinations thereof;

anti-virals, non-limiting examples of which include amantidine, rimantidine, pleconaril, zanamivir, oseltamivir, and combinations thereof;

mucolytics, non-limiting examples of which include ambroxol, N-acetylcysteine, and combinations thereof;

demulcents, non-limiting examples of which include glycerin, honey, pectin, gelatin, slippery elm bark, liquid sugar, glycyrrhizin (licorice) and combinations thereof;

anesthetics, non-limiting examples of which include phenol, menthol, dyclonine HCl, benzocaine, lidocaine, hexylresorcinol, and combinations thereof;

antibiotics, non-limiting examples of types of which include nitroimidazole antibiotics, tetracyclines, penicillin-based antibiotics such as amoxicillin, cephalosporins, carbopenems, aminoglycosides, macrolide antibiotics, lincosamide antibiotics, 4-quinolones, fluoroquinolones, rifamycins, macrolides, nitrofurantoin, and combinations thereof; and

any pharmaceutically acceptable salts, metabolites, and combinations thereof of the above-listed actives.

The dosage units of the present invention can comprise from about 0% to about 90%, alternatively from about 0.0001% to about 75%, alternatively from about 0.001% to about 50%, alternatively from about 0.01 % to about 25%, alternatively from about 0.01% to about 15%, and alternatively from about 0.01% to 10% non-prescription or prescription pharmaceutical active, by weight of the composition forming the dosage unit.

The dosage units can comprise from about 0.001 mg to about 1000 mg, alternatively from about 2.5 mg to about 750 mg, and alternatively from about 5 mg to about 650 mg of the non-prescription or prescription pharmaceutical active, per dosage unit.

The dosage units can also comprise other actives useful to treat respiratory conditions, non-limiting examples of which include vitamins, minerals, elements, plant-derived materials, energy-boosting materials, probiotics, fiber, prebiotics, and combinations thereof. Such other actives are described below.

The dosage units can be administered in a single daily dose, or multiple daily doses.

### Gastrointestinal

The dosage units and systems of the present invention can comprise one or more actives useful to treat a gastrointestinal condition. Gastrointestinal conditions encompass a broad range of conditions, including viral infections, bacterial infections, auto-immune conditions, genetic conditions and the like. Gastrointestinal conditions may present with any of a variety of symptoms, associated with a disruption in function of the digestive system, such as diarrhea, constipation, upset stomach, vomiting, sour stomach, cramps, gas, bloating, stomach ache, and the like. Actives typically used to treat these symptoms generally fall into the following classifications: laxative, anti-diarrheal, anti-emetic, anti-inflammatory, antacid, and anti-flattulent. Such actives can be non-prescription pharmaceutical actives and prescription pharmaceutical actives.

Dosage units for treating gastrointestinal symptoms associated with gastrointestinal conditions can be manufactured in a number of product forms, non-limiting examples of the most common including tablets, dragees, caplets, softgel capsules, solid-filled capsules, liquid-filled capsules, enteric-coated forms, sustained-release forms, solid lozenges, liquid-filled lozenges, mouth and throat drops, gums, confectionaries, “gummies”, effervescent tablets, dry dissolvable powders, dissolvable film strips, sublingual tablets, buccal tablets, syrups, elixirs and liquids for swallowing, patches for transdermal administration of actives, treats, biscuits, suppositories, as well as topical creams and lotions that release agents that are absorbed into and through the skin and/or mucus membranes into the gastrointestinal tract, and combinations thereof.

Non-limiting examples of non-prescription and prescription pharmaceutical actives suitable for use with gastrointestinal conditions include:

anti-diarrheal, non-limiting examples of which include loperamide, bismuth-containing compositions, kaolin, pectin, clays such as attapulgite, activated charcoal, and combinations thereof;

laxative, non-limiting examples of which include fiber, resistant starch, resistant maltodextrin, pectin, cellulose, modified cellulose, polycarophil, senna, sennosides, bisacodyl, sodium phosphate, docusate, magnesium citrate, mineral oil, glycerin, aloe, castor oil, magnesium hydroxide, and combinations thereof;

anti-nausea and anti-emetic, non-limiting examples of which include bismuth containing compositions, phosphated carbohydrates, diphenhydramine, cyclizine, meclizine, and combinations thereof;

antacid, non-limiting examples of which include sodium bicarbonate, sodium carbonate, calcium carbonate, magnesium carbonate, magnesium hydroxide, aluminum hydroxide, magnesium silicates, alginic acids, sodium alginate, magaldrate, and combinations thereof;

anti-flattulent/anti-gas, non-limiting examples of which include simethicone, activated charcoal, lactase, and combinations thereof;

H2 receptor antagonists, non-limiting examples of which include famotidine, ranitidine, ciemtidine, nitazidine, and combinations thereof;

proton pump inhibitors, non-limiting examples of which include omeprazole, lansoprazole, esomeprazole, pantoprazole, rabeprazole, and combinations thereof;

anti-inflammatories, non-limiting examples of which include mesalamine; and any pharmaceutically acceptable salts, metabolites, and combinations thereof of the above-listed actives.

The dosage units of the present invention can comprise from about 0.001% to about 99%, alternatively from about 0.01% to about 99%, alternatively from about 0. 1% to about 99%, alternatively from about 1% to about 99%, and alternatively from about 5% to about 95%, non-prescription or prescription pharmaceutical active, by weight of the composition forming the dosage unit.

The dosage units can comprise from about 0.001 mg to about 5 g, alternatively from about 0.01 mg to about 2 g, alternatively from about 0.1 mg to about 1000 mg, and alternatively from about 1 mg to about 1000 mg of non-prescription or prescription pharmaceutical active, per dosage unit.

The dosage units can also comprise other actives useful to treat gastrointestinal conditions, non-limiting examples of which include vitamins, minerals, elements, plant-derived materials, energy-boosting materials, probiotics, fiber, prebiotics, and combinations thereof Such other actives are described below.

The dosage units can be administered in a single daily dose or multiple daily doses.

### Other Actives

The dosage units and systems of the present invention can comprise one or more other actives which can be used to treat and/or prevent respiratory conditions, can be used to treat and/or prevent gastrointestinal conditions, and can be used to treat and/or prevent various other conditions and/or also provide benefits for overall health and well-being. Overall health and well-being encompasses a broad range of desired benefits and benefit types, including respiratory health, gastrointestinal health, immune health, mobility and joint health, cardiovascular health, skin health, oral/dental health, hair health, eye health, reproductive health (including menstrual health), ear, nose and throat health, and the like.

Users may desire a variety of benefits, non-limiting examples of which include reduced incidence and severity of respiratory conditions and symptoms thereof; reduced incidence and severity of gastrointestinal conditions and symptoms thereof; reduced incidence and severity of menstrual symptoms; reduced incidence and severity of symptoms of disorders of the ear, nose and throat; reduced incidence and severity of symptoms and effects of: inflammatory disorders, immunodeficiency, cancer (particularly those of the gastrointestinal and immune systems), appendicitis, autoimmune disorders, multiple sclerosis, Alzheimer's disease, amyloidosis, rheumatoid arthritis, arthritis, diabetes mellitus, insulin resistance, bacterial infections, viral infections, fungal infections, periodontal disease, urogenital disease, surgical associated trauma, surgical-induced metastatic disease, sepsis, weight loss, weight gain, excessive adipose tissue accumulation, anorexia, fever control, cachexia, wound healing, ulcers, gut barrier infection, circulatory disorders, coronary heart disease, anaemia, disorders of the blood coagulation system, renal disease, disorders of the central nervous system, hepatic disease, ischaemia, nutritional disorders, osteoporosis, endocrine disorders, and epidermal disorders.

Non-limiting examples of health benefits include ameliorating or reducing the effects of aging including mental awareness and activity levels, preventing weight loss during and following infection; improving glucose control, including improving insulin sensitivity, reducing insulin resistance, and attenuating postprandial glucose absorption; good, maintained and/or improved mobility and joint function; lowered cholesterol and lowered blood pressure; improved skin look and tone, improved hair look and feel, and combinations thereof.

Non-limiting examples of such other actives used to provide such benefits include vitamins, minerals, elements, plant-derived materials, energy-boosting materials, probiotics, fiber, prebiotics, and combinations thereof.

Dosage units suitable for use with the other actives herein are manufactured in a number of product forms, non-limiting examples of the most common including tablets, dragees, caplets, softgel capsules, solid-filled capsules, liquid-filled capsules, enteric-coated forms, sustained-release forms, solid lozenges, liquid-filled lozenges, mouth and throat drops, gums, confectionaries, “gummies”, effervescent tablets, dry dissolvable powders, dissolvable film strips, syrups, elixirs and liquids for swallowing, suppositories, sublingual tablets, buccal tablets, patches for transdermal delivery of actives, drinks, and food products including treats and biscuits; as well as topical anti-microbial compositions, topical creams and lotions that release agents that are absorbed into and through the skin and/or mucus membranes, inhalants and topical creams and lotions that release volatile agents that are inhaled through the nose into the respiratory tract.

### Vitamins

The dosage units and systems of the present invention can comprise one or more vitamins, non-limiting examples of which include provitamin and all forms of Vitamins C, D, A, B, E, and combinations thereof.

When certain vitamins, (also certain minerals, metals, elements and the like), are included as components in capsule, tablet and powder forms, the actual amounts of these many of these components, in grams per unit dose, are often extremely small, and make the individual components difficult to handle, measure and process. Therefore such components are commonly prepared or purchased as a premix in or on a carrier such as sucrose or lactose. With respect to the weight percent of a given vitamin as a percent of a premix or vitamin-carrier mix, such percentages can vary greatly depending on the vitamin and the amount of vitamin desired, as would be understood by one of skill in the art. Generally, however, for vitamins in or on a carrier, the vitamin can comprise, as a weight percent of vitamin to carrier, from about 0.0001% to about 50%, alternatively from about 0.001% to about 45%, alternatively from about 0.001% to about 40%, by weight of the vitamin-carrier composition.

### Vitamin C

The dosage units and systems of the present invention can comprise Vitamin C. It is believed that over 20% of subjects with colds have suboptimal levels of Vitamin C. The preferred form of Vitamin C for use in the present invention is as ascorbic acid or an equivalent salt of ascorbic acid (i.e. calcium ascorbate) or an equivalent derivative of ascorbic acid. The vitamin C can either be in an immediate release form or a sustained release form.

The Vitamin C can be administered in a single daily dose or multiple daily doses.

The dosage units can comprise from about l mg to about 5000 mg, alternatively from about 20 mg to about 2000 mg, alternatively from about 60 mg to about 1500 mg, and alternatively from about 100 mg to about 1000 mg of Vitamin C, per dosage unit.

The systems can provide from about 1 mg to about 5000 mg, alternatively from about 20 mg to about 2000 mg, alternatively from about 60 mg to about 1500 mg, and alternatively from about 100 mg to about 1000 mg of Vitamin C, per day.

### Vitamin D

The dosage units and systems of the present invention can comprise Vitamin D. Non-limiting examples of Vitamin D suitable for use in the present invention include Vitamin D3 (cholecalciferol), Vitamin D2 (ergocalciferol) and combinations thereof. Additional non-limiting examples include metabolites of Vitamin D including calcidiol, calcitriol and combinations thereof. The Vitamin D can be derived from natural or synthetic sources, including from an extract of solanum glaucophylum (malacoxylon), trisetum flavescens (goldhafer) or cestrum diurnum. Both the pure Vitamin D and/or glycosides of the Vitamin D can be used. Vitamin D can be used to treat and/or prevent a respiratory condition, and/or provide overall health and wellness benefits.

The Vitamin D can be administered in a single daily dose or multiple daily doses.

The dosage units can provide, in a single daily dose or multiple daily doses, from about 50 IU to about 500,000 IU, alternatively from about 500 IU to about 500,000 IU, alternatively from about 1,000 IU to about 500,000 IU, alternatively from about 2,000 IU to about 100,000 IU, alternatively from about 10,000 IU to about 50,000 IU, and alternatively from about 20,000 IU to about 40,000 IU, of cholecalciferol per day.

To treat symptoms of a respiratory condition that is already underway, a mammal, for example a human, can be administered, in a daily single dose, or multiple daily doses, from about 50 IU to about 500,000 IU, alternatively from about 500 IU to about 500,000 IU, alternatively from about 1000 IU to about 500,000 IU, alternatively from about 5,000 IU to about 500,000 IU, alternatively from about 10,000 IU to about 100,000 IU, and alternatively from about 20,000 to about 50,000 IU of cholecalciferol per day.

To treat or prevent the symptoms of a respiratory condition, a mammal can be administered, in a single dose or multiple daily doses, from about 50 IU to about 10,000 IU, alternatively from about 500 IU to about 10,000 IU, alternatively from about 1,000 IU to about 5,000 IU, alternatively from about 2,000 IU to about 5,000 IU, and alternatively from about 2,000 IU to about 4,000 IU of cholecalciferol per day.

The dosage units and systems can also provide Vitamin D2 (ergocalciferol). The dosage units can provide, in a single daily dose or multiple daily doses, from about 50 IU to about 500,000 IU, alternatively from about 500 IU to about 500,000 IU, alternatively from about 1,000 IU to about 500,000 IU, and alternatively from about 5,000 IU to about 500,000 IU of Vitamin D2, per day.

The dosage units can comprise from about 1.25 μg to about 12.5 mg, alternatively from about 12.5 μg to about 12.5 mg, alternatively from about 25 μg to about 12.5 mg, and alternatively from about 125 μg to about 12.5 mg of Vitamin D3 and/or D2, per dosage unit.

### Vitamin A

The dosage units and systems of the present invention can also comprise Vitamin A and/or pro-vitamin forms of vitamin A such as carotene(s). Vitamin A and carotene can be obtained from either animal or plant sources. The animal form of carotene is divided between retinol and dehydroretinol whereas the plant carotene can be split into four very potent groups—alpha-carotene, beta-carotene, gamma-carotene and crypto-carotene. Vitamin A can provide a variety of overall health and wellness benefits.

Non-limiting examples of the Vitamin A useful in the present invention include vitamin A, retinol, retinyl palmitate, retinyl acetate, retinyl proprionate, beta-carotene, alpha-carotene, beta-cryptoxanthin, and mixtures thereof.

The Vitamin A can be administered in a single daily dose or multiple daily doses.

The dosage units and systems can provide, in a single daily dose or multiple daily doses, from about 100 IU to about 10,000 IU, alternatively from about 300 IU to about 5,000 IU, alternatively from about 400 IU to about 2,000 IU, and alternatively from about 500 IU to about 1,000 IU of Vitamin A, per day. The amount of Vitamin A species can be expressed as IU or as RAE (Retinol Activity Equivalent), which is equal to an equivalent amount of retinol in micrograms. For example, 10,000 IU Vitamin A is equivalent to 3000 RAE or 3000 μg retinol.

The dosage units can comprise from about 30 μg to about 4545 μg, alternatively from about 90 μg to about 1500 μg, alternatively from about 120 μg to about 600 μg, and alternatively from about 150 μg to about 300 μg of Vitamin A (as retinol), per dosage unit.

### B Vitamins

The dosage units and systems of the present invention can comprise one or more B Vitamins. Compositions containing eight specific B Vitamins are generally referred to as a “Vitamin B complex”. Individual B Vitamin compositions are referred to by the specific name of each vitamin (e.g. B₁, B₂, B₃, etc). The B Vitamins often work together to deliver a number of health benefits non-limiting examples of which include, maintenance and support of metabolic rate, maintenance of healthy skin and muscle tone, enhanced immune and nervous system function, promote cell growth and division, and together can also help combat the symptoms of stress, depression, and cardiovascular disease. All B Vitamins are water soluble, and are dispersed throughout the body. Most of the B Vitamins must be replenished daily, since any excess is excreted in the urine.

Non-limiting examples of Vitamin B useful in the present invention include vitamin B1 (thiamin), Vitamin B2 (Riboflavin), Vitamin B3 (niacin), Vitamin B5 (pantothenic acid), Vitamin B6 (pyridoxine, pyridoxal, or pyridoxamine), Vitamin B7 (Biotin), Vitamin B9 (Folic acid), Vitamin B12 (cyanocobalmin), and combinations thereof

B Vitamins described below can be administered in a single daily dose or multiple daily doses.

The dosage units can comprise from about 200 ug to about 50 mg, alternatively from about 400 μg to about 20 mg, and alternatively from about 500 μg to about 10 mg of Vitamin B1, per dosage unit. The systems can provide from about 200 ug to about 50 mg, alternatively from about 400 μg to about 20 mg, and alternatively from about 500 μg to about 10 mg of Vitamin B1, per day.

The dosage units can comprise from about 100 μg to about 200 mg, alternatively from about 200 μg to about 100 mg, and alternatively from about 500 μg to about 50 mg of Vitamin B2, per dosage unit. The systems can provide from about 100 μg to about 200 mg, alternatively from about 200 μg to about 100 mg, and alternatively from about 500 μg to about 50 mg of Vitamin B2, per day.

The dosage units can comprise from about 1 mg to about 500 mg, alternatively from about 2 mg to about 250 mg, and alternatively from about 5 mg to about 100 mg of Vitamin B3, per dosage unit. The systems can provide from about 1 mg to about 500 mg, alternatively from about 2 mg to about 250 mg, and alternatively from about 5 mg to about 100 mg of Vitamin B3, per day.

The dosage units can comprise from about 500 μg to about 1000 mg, alternatively from about 1000 μg to about 500 mg, and alternatively from about 2000 μg to about 100 mg of Vitamin B5, per dosage unit. The systems can provide from about 500 μg to about 1000 mg, alternatively from about 1000 μg to about 500 mg, and alternatively from about 2000 μg to about 100 mg of Vitamin B5, per day.

The dosage units can comprise from about 200 μg to about 500 mg, alternatively from about 500 μg to about 250 mg, and alternatively from about 1000 μg to about 100 mg of Vitamin B6, per dosage unit. The systems can provide from about 200 μg to about 500 mg, alternatively from about 500 μg to about 250 mg, and alternatively from about 1000 μg to about 100 mg of Vitamin B6, per day.

The dosage units can comprise from about 200 μg to about 500 mg, alternatively from about 500 μg to about 250 mg, and alternatively from about 1000 μg to about 100 mg of Vitamin B6, per dosage unit. The systems can provide from about 200 μg to about 500 mg, alternatively from about 500 μg to about 250 mg, and alternatively from about 1000 μg to about 100 mg of Vitamin B6, per day.

The dosage units can comprise from about 50 μg to about 2000 μg, alternatively from about 100 μg to about 1000 μg, and alternatively from about 200 μg to about 500 μg of Vitamin B9, per dosage unit. The systems can provide from about 50 μg to about 2000 μg, alternatively from about 100 μg to about 1000 μg, and alternatively from about 200 μg to about 500 μg of Vitamin B9, per day.

The dosage units can comprise from about 0.5 μg to about 3000 μg, alternatively from about 1 μg to about 1500 μg, and alternatively from about 2 μg to about 750 μg of Vitamin B12, per dosage unit. The systems can comprise from about 50 μg to about 2000 μg, alternatively from about 100 μg to about 1000 μg, and alternatively from about 200 μg to about 500 μg of Vitamin B9, per day.

### Vitamin E

The dosage units and systems of the present invention can comprise Vitamin E. Vitamin E is a lipid soluble antioxidant and provides defenses against cellular oxidative damage. The term “Vitamin E” typically includes eight different chemical forms: four tocopherols and four tocotrienols. The most biologically active form of vitamin E is alpha-tocopherol.

The Vitamin E can be administered in a single daily dose or multiple daily doses.

The dosage units can comprise from about 1 mg to about 1000 mg of vitamin E, alternatively from about 1 mg to about 800 mg of vitamin E, and alternatively from about 2 mg to about 200 mg of vitamin E, per dosage unit.

The systems can comprise from about 1 mg to about 1000 mg of vitamin E, alternatively from about 1 mg to about 800 mg of vitamin E, and alternatively from about 2 mg to about 200 mg of vitamin E, per day.

### Minerals, Metals, and Elements

The dosage units and systems of the present invention can comprise minerals, metals and/or elements. Non-limiting examples of minerals, metals, and elements useful in the systems of the present invention include: zinc, iron, calcium, iodine, copper and selenium. Adequate intake of iron, zinc, copper and selenium support a Th1 cytokine-mediated immune response which helps circumvent an anti-inflammatory Th2 response and an increased risk of extracellular infections. When present, the minerals, metals and/or elements can be on or in a suitable carrier, and comprise from about 1% to about 50% by weight and alternatively from about 2% to about 30%, by weight of the composition comprising the mineral, metal or element and the carrier.

The minerals, metals, and elements described herein can be administered in a single daily dose or multiple daily doses.

### Zinc

The dosage units and systems of the present invention can comprise zinc. Zinc is a trace element important to many biological and biochemical pathways. Zinc salts are effective against pathogens in direct application, and both zinc gluconate and zinc gluconate glycine have been shown to shorten the duration of symptoms of the common cold.

The dosage units can comprise zinc in an amount from about 1 mg to about 50 mg, alternatively from about 1 mg to about 30 mg, and alternatively from about 1 mg to about 25 mg, per dosage unit.

The systems can provide zinc in an amount from about 1 mg to about 50 mg, alternatively from about 1 mg to about 30 mg, and alternatively from about 1 mg to about 25 mg, per day.

### Iron

The dosage units and systems of the present invention can comprise iron. Iron (as Fe²⁺, ferrous ion) is a necessary trace element used by almost all living organisms. It is used in hemoglobin which carries oxygen to the cells. Too little iron can cause anemia, resulting in fatigue and tiredness and has been associated with decreased cellular immunity. However, too much iron can be lethal.

A non-limiting example of iron suitable for use with the present invention is the bisclycinate salt form of iron, available under the tradename “Ferrochel” from Albion Laboratories Inc., Clearfield, Utah, USA.

The dosage units can comprise from 2 mg to about 18 mg, alternatively from about 3 mg to about 15 mg, and alternatively from about 3 mg to about 10 mg of iron, per dosage unit.

The systems can provide from 2 mg to about 18 mg, alternatively from about 3 mg to about 15 mg, and alternatively from about 3 mg to about 10 mg of iron, per day.

### Calcium

The dosage units and systems of the present invention can comprise calcium. Calcium is essential for all living organisms, and is a major material used in mineralization of bones and shells. Calcium is essential for the normal development and maintenance of bones and teeth.

The dosage units can comprise from about 200 to about 1500 mg, alternatively from about 250 mg to about 1200 mg, and alternatively from about 500 mg to about 1000 mg of calcium, per dosage unit.

The systems can provide from about 200 to about 1500 mg, alternatively from about 250 mg to about 1200 mg, and alternatively from about 500 mg to about 1000 mg of calcium, per day.

### Iodine

The dosage units and systems of the present invention can comprise iodine. Iodine is required in trace amounts in most living organisms, and is commonly used in medicine. Although only generally present and required in trace amounts, iodine has a key role in overall wellness, particularly in children.

The dosage units can comprise from about 20 μg to about 1 mg iodine, alternatively from about 30 μg to about 500 μg, and alternatively from about 30 μg to about 100 μg of iodine, per dosage unit.

The systems can provide from about 20 μg to about 1 mg iodine, alternatively from about 30 μg to about 500 μg, and alternatively from about 30 μg to about 100 μg of iodine, per day.

### Copper

The dosage units and systems of the present invention can comprise copper. Copper is a trace element that is used for biological electron transport, wound healing, red blood cell production, and immune support and performance. Copper has been used as an anti-microbial and an anti-arthritic agent.

The dosage units can comprise from about 200 μg to 10 mg, alternatively from about 500 μg to about 9 mg, and alternatively from about 1 mg to about 9 mg, per dosage unit.

The systems can provide from about 200 μg to 10 mg, alternatively from about 500 μg to about 9 mg, and alternatively from about 1 mg to about 9 mg, per day.

### Selenium

The dosage units and systems of the present invention can comprise selenium. Although it is toxic in large doses, selenium is an essential micronutrient for animals. In humans, selenium is a trace element nutrient which functions as a cofactor for reduction of antioxidant enzymes. Selenium may act as an antioxidant and/or enhance immune activity.

The dosage units can comprise from about 15 μg to about 400 mg, alternatively from about 20 μg to about 300 mg, and alternatively from about 50 μg to about 200 mg of selenium, per dosage unit.

The dosage units can provide from about 15 μg to about 400 mg, alternatively from about 20 μg to about 300 mg, and alternatively from about 50 μg to about 200 mg of selenium, per day.

### Plant-Derived Materials

The dosage units and systems of the present invention can comprise plant-derived materials. As used herein, non-limiting examples of plant-derived materials include those used in traditional native American, Chinese, Aryuvedic and Japanese medicine, including flowers, leaves, stems and roots of plants as well as extracts and isolated active components from the flower, leaves, stems, and roots of plants.

Some particularly useful plant-derived materials are described below. Particularly useful plant-derived materials are those that have beneficial respiratory, gastrointestinal, overall health and energy effects.

The plant-derived materials can be administered in a single dose or multiple daily doses.

### Respiratory

The dosage units and systems of the present invention can also comprise plant-derived materials that can be particularly useful in preventing and/or treating respiratory conditions, and/or maintaining respiratory health. Non-limiting examples of such other plant-derived materials include: Andrographis (Andrographis paniculata), Garlic (Allium sativum L.), Eleutherococcus senticosus (Siberian ginseng), a guaiacol component (from oils of cassia (Cinnamomum aromaticum), clove (Syzygium aromaticum, Eugenia aromaticum, Eugenia caryophyllata), or cinnamon (Cinnamomum zeylanicum, Cinnamomum verum, Cinnamomum loureiroi, Cinnamomum camphora, Cinnamomum tamala, Cinnamomum burmannii)), borage seed oil (Borago officinalis), sage (Salvia officinalis, Salvia lavandulaefolia, Salvia lavandulifolia), Astragalus (Astragalus membraneceus), Boneset (Eupatorium perfoliatum), Chamomile (Matricaria recutita, Chamaemelum nobile), Cordyceps (Cordyceps sinensis), Echinacea (Echinacea angustifolia DC, Echinacea pallida, Echinacea purpurea), Elder (Sambucas nigra L.), Euphorbia, Ginseng (American ginseng, Asian ginseng, Chinese ginseng, Korean red ginseng, Panax ginseng: Panax ssp. Including P. ginseng C.C. Meyer, and P. quinquefolius L.), Goldenseal (Hydrastis canadensis L.), Greater celandine (Chelidonium majus), Horseradish (Armoracia rusticana, Cochlearia armoracia), Kiwi (Actinidia deliciosa, Actinidia chinensis), Maitake mushrooms (Grifola frondosa) Mistletoe (Visvum album L.), Geranium (Pelargonium sidoides), Peppermint/Peppermint oil (Mentha x peperita L.), Propolis, Slippery elm (Ulmus rubra Muhl, Ulmus fulva Michx), Sorrel (Rumex acetosa L., Rumex acetosella L.), Thyme/Thymus extract (Thymus vulgaris L.), Wild indigo (Baptisia australis), quercetin (a flavanol), and combinations and/or mixtures thereof.

Non-limiting examples of plant-derived materials particularly useful with the present invention include Andrographis paniculata, Allium sativum, Eleutherococcus senticosus (Siberian ginseng) and a guaiacol component which are described below.

Andrographis paniculata

The dosage units and systems of the present invention can comprise an andrographis extract, an active component thereof, or mixtures thereof. As used herein, the andrographis is a plant of the genus Andrographis, having a limited number of species within this genus largely present in Asia. Only a few of the species are medicinal. In one embodiment, the plant is of the species Andrographis paniculata, which may be referenced as Kalmegh in Ayurvedic medicine. Andrographis is typically standardized by quantifying the total amount of andrographolides, which often make up 5 to 20% of the extract.

Andrographis has been shown to be effective in the treatment of colds and flu, and can aid in reducing to an extent the symptoms or duration of colds. Andrographolides are the principal components of andrographis.

The dosage units can comprise Andrographis paniculata in amounts from about 5 mg to about 50 mg, alternatively from about 10 mg to about 40 mg, and alternatively from about 15 mg to about 30 mg of andrographolides, per dosage unit.

The systems can provide Andrographis paniculata in amounts from about 5 mg to about 50 mg, alternatively from about 10 mg to about 40 mg, and alternatively from about 15 mg to about 30 mg of andrographolides, per day.

Allium sativum

The dosage units and systems of the present invention can comprise Allium sativum (garlic). Allium sativum has been shown to be effective at reducing many of the cytokines and chemokines involved in the immune response to viral infections. A combination of Allium sativum, and/or Allicin, a component of Allium sativum, in the compositions of the present invention may provide relief of cold and flu symptoms.

The dosage units can comprise from about 0.01% to about 90%, alternatively from about 0.1% to about 35%, alternatively from about 1% to about 15%, alternatively from about 1% to about 10%, and alternatively from about 3% to about 10% of Allium sativum, by weight of the composition of the dosage unit.

The dosage units can comprise from about 100 mg to about 10,000 mg, alternatively from about 200 mg to about 5000 mg, alternatively from about 500 mg to about 2000 mg of Allium sativum, per dosage unit.

The systems can provide from about 100 mg to about 10,000 mg, alternatively from about 200 mg to about 5000 mg, alternatively from about 500 mg to about 2000 mg of Allium sativum, per day.

The dosage units can comprise from about 1000 μg to about 100,000 μg, alternatively from about 2000 μg to about 50,000 μg, and alternatively from about 5000 μg to about 20,000 μg of Allicin, per dosage unit.

The systems can provide from about 1000 μg to about 100,000 μg, alternatively from about 2000 μg to about 50,000 μg, and alternatively from about 5000 μg to about 20,000 μg of Allicin, per day.

Eleutherococcus senticosus

The dosage units and systems of the present invention can comprise Eleutherococcus senticosus extract. Eleutherococcus is an adaptogen, is anticholesteremic, is mildly anti-inflammatory, is antioxidant, may enhance immune function, and is a nervine and an immune tonic.

The dosage units can comprise from about 0.001 mg to about 1500 mg, alternatively from about 0.01 to about 1000 mg alternatively about 0.1 mg to about 500 mg, alternatively from about 1 to about 250 mg, and alternatively from about 1 mg to about 100 mg of Eleutherococcus senticosus extract, per dosage unit.

The systems can provide from about 0.001 mg to about 1500 mg, alternatively from about 0.01 to about 1000 mg alternatively about 0.1 mg to about 500 mg, alternatively from about 1 to about 250 mg, and alternatively from about 1 mg to about 100 mg of Eleutherococcus senticosus extract, per day.

### Guaiacol Component

The dosage units and systems of the present invention can comprise a guaiacol component. The guaiacol component can be a component mixture containing guaiacol or a 4-substituted derivative thereof. Non-limiting examples of such 4-substituted derivatives of guaiacol include eugenol, iso-eugenol, dihydroeugenol, vanillyl butyl ether, vanillin (4-formyl-guaiacol), 5-propenylguaethol, 4-ethyl-2-methoxyphenol, 4-allyl-2-methoxyphenol acetate, and 4-methyl guaiacol. In one embodiment, the 4-substituted derivative of guaiacol is eugenol.

Cassia, clove, and cinnamon each contain guaiacol or 4-substituted derivatives thereof, or mixtures thereof. As such, essential oils, extracts or any product derived from cassia, clove, cinnamon, or any mixture thereof can be used as source of the guaiacol component herein. Essential oils of cassia, clove, or cinnamon can be particularly useful. Clove oil can be particularly useful. Products derived from cassia, clove or cinnamon may contain eugenol at useful levels.

The guaiacol component can comprise from about 0.0001% to about 1%, alternatively from about 0.001% to about 0.5%, alternatively about 0.001% to about 0.07%, and alternatively from about 0.001% to about 0.02%, by weight, of the composition of a dosage unit.

### Gastrointestinal

Other plant-derived materials useful in systems of the present invention can exert beneficial effects on the gastrointestinal tract, non-limiting examples of which include soothing or demulcent effects, gas reducing or carminative effects, anti-diarrheal or astringent effects, laxative or aperient, cathartic, purgative or hydrogogue effects, analgesic, antispasmodic or relaxation effects, stimulant or bitter effects, or digestive aiding effects.

Non-limiting examples of such other plant-derived materials useful in the methods and kits of the present invention include the ginger Family (Zigiberaceae), licorice root (Glycyrrhizin glabra), marshmallow root (Althea officinalis, Althea radix), Chamomile (Matricariae flos, Chamaemelum nobile), Fennel oil, Fennel Seed (Foeniculum vulgare), Caraway oil, Caraway seed (Carum carvi, Carvi fructus, Carvi aetheroleum), Lemon Balm (Melissae folium, Melissa), Horehound Herb (Murrubii herba), Flaxseed alpha-linoleic acid (Lini semen), and combinations thereof.

Materials from the ginger Family (Zigiberaceae) such as the non-limiting example of Zingiber officinale are particularly useful.

Ginger can be used in a form selected from the group consisting of rhizome (root), equivalent extract, tincture, oil, infusion, decoction, crystals, powder, and combinations thereof.

The dosage units can comprise from about 50 mg to about 10 g, alternatively from about 50 mg to about 5 g, and alternatively from about 100 mg to about 5 g of ginger (Zingiber officinale), per dosage unit.

The systems can provide from about 50 mg to about 10 g, alternatively from about 50 mg to about 5 g, and alternatively from about 100 mg to about 5 g of ginger (Zingiber officinale), per day.

### Energy Benefits

The dosage units and systems of the present invention can comprise materials having energy boosting/enhancing benefits. Such energy benefits are useful for overall health and well-being, as well as being useful in treating conditions such as respiratory and gastrointestinal conditions, to provide individuals afflicted with such conditions with more energy or a perception of more energy to enable such individuals to maintain their daily routines while treating a condition such as a respiratory or gastrointestinal condition.

Non-limiting examples of such materials include the following, many of which have multiple benefits including benefits for respiratory and gastrointestinal conditions: caffeine (a stimulant and diuretic), Vitamin B complex, green and black tea (which can be used for stimulant and diuretic properties of the caffeine contained therein), taurine, rhodiola rosea, Siberian ginseng (Eleutherococcus senticosus), Vitamin C, iron, CoQ10, L-carnitine, L-Theanine, Vitamin D, guarana (Paullinia cupana), magnesium, Schizandra chinensis, Yerba Mata (Ilex paraguariensis), Goji (Wolfberry), quercetin (a flavanol), amalaki (Indian gooseberry), acai (from genus Euterpe), maca (Lepidium meyenii), ginkgo biloba, glucuronolactone, panax ginseng (from species within Panax, a genus of 11 species of slow-growing perennial plants with fleshy roots, in the family Araliaceae), Echinacea (genus of nine species of herbaceous plants in the Family Asteraceae), rooibos (Aspalathus linearis), DHEA, aromas and aromatherapy, noni (Morinda citrifolia), mangosteen (Garcinia mangostana), and selenium.

The energy boosting material can be administered in a single daily dose or multiple daily doses.

The dosage units can comprise from about 1 μg to about 10 g, alternatively from about 1 mg to about 5 g, and alternatively from about 100 mg to about 5 g of energy-boosting/enhancing material, per dosage unit.

The systems can provide from about 1 μg to about 10 g, alternatively from about 1 mg to about 5 g, and alternatively from about 100 mg to about 5 g of energy-boosting/enhancing material, per day.

### Probiotics

The dosage units and systems of the present invention can comprise a probiotic. Proboitcs can be useful in treating and/or preventing respiratory conditions, treating and/or preventing gastrointestinal conditions, as well as providing overall health benefits. As used herein, “probiotic” includes natural and/or genetically modified microorganisms, viable or dead; processed compositions of micro-organisms; their constituents and components such as proteins and carbohydrates or purified fractions of bacterial ferments; that beneficially affect a host. The general use of probiotics herein is in the form of viable cells. However, use can be extended to non-viable cells such as killed cultures or compositions containing beneficial factors expressed by the probiotic. Killed cultures may include thermally killed microorganisms, or microorganisms killed by exposure to altered pH or subjected to pressure. For the purpose of the present invention, “probiotic” is further intended to include metabolites generated by the microorganisms during fermentation, if they are not separately indicated. These metabolites may be released to the medium of fermentation, or they may be stored within the microorganism. As used herein “probiotic” also includes bacteria, bacterial homogenates, bacterial proteins, bacterial extracts, bacterial ferment supernatants, and mixtures thereof, which perform beneficial functions to a host animal when given at a therapeutically effective amount.

As used herein, the term “therapeutically effective amount” with reference to the probiotic described herein, means that amount of the probiotic sufficient to provide the desired effect or benefit to a host animal in need of treatment, yet low enough to avoid adverse effects such as toxicity, irritation, or allergic response, commensurate with a reasonable benefit/risk ratio when used in the manner of the present invention. The specific “therapeutically effective amount” will vary with such factors as the particular condition being treated, the physical condition of the host animal, the duration of the treatment, the nature of concurrent therapy (if any), the specific dosage form to be used, the carrier employed, the solubility of the dose form, and the particular dosing regimen.

The abbreviation “CFU” refers to “colony-forming unit” and as used herein designates the number of probiotic cells revealed by microbiological counts on agar plates, as will be commonly understood in the art.

Non-limiting examples of probiotic bacteria suitable for use herein include strains of Streptococcus lactis, Streptococcus cremoris, Streptococcus diacetylactis, Streptococcus thermophilus, Lactobacillus bulgaricus, Lactobacillus acidophilus, Lactobacillus helveticus, Lactobacillus bifidus, Lactobacillus casei, Lactobacillus lactis, Lactobacillus plantarum, Lactobacillus rhamnosus, Lactobacillus delbruekii, Lactobacillus thermophilus, Lactobacillus fermentii, Lactobacillus salivarius, Lactobacillus reuteri, Lactobacillus brevis, Lactobacillus paracasei, Lactobacillus gasseri, Pediococcus cerevisiae, Bifidobacterium longum, Bifidobacterium infantis, Bifidobacterium adolescentis, Bifidobacterium bifidum, Bifidobacterium animalis, Bifidobacterium pseudolongum, Bifidobacterium thermophilum, Bifidobacterium lactis, Bifidobacterium bulgaricus, Bifidobacterium breve, Bifidobacterium subtilis, Escherichia coli and strains of the genera including Bacillus, Bacteroides, Enterococcus (e.g., Enterococcus faecium) and Leuconostoc, and mixtures and/or combinations thereof.

Embodiments of the dosage units of the present invention comprise strains of lactic acid bacteria selected from the genera Lactobacillus and Bifidobacterium, such as Lactobacilius acidophilus, and Bifidobacterium lactis, and combinations and/or mixtures thereof.

In one embodiment, the dosage unit comprises a composition comprising a therapeutically effective amount of the Lactobacillus.

Non-limiting examples of Lactobacillus suitable for use herein include strains of Lactobacillus bulgaricus, Lactobacillus acidophilus, Lactobacillus helveticus, Lactobacillus bifidus, Lactobacillus casei, Lactobacillus lactis, Lactobacillus plantarum, Lactobacillus rhamnosus, Lactobacillus delbruekii, Lactobacillus thermophilus, Lactobacillus fermentii, Lactobacillus salivarius, Lactobacillus reuteri, Lactobacillus brevis, Lactobacillus paracasei, Lactobacillus gasseri, and combinations thereof.

The probiotic can be administered in a single daily dose or multiple daily doses.

The dosage units can comprise at least about 10³ CFU, alternatively from about 10³ to about 10¹⁴ CFU, alternatively from about 10⁶ to about 10⁶ CFU, and alternatively from about from about 10⁸ to about 10¹¹ CFU of Lactobacillus, per dosage unit. The Lactobacillus may be administered in either viable form, or as killed cells, or distillates, isolates or other fractions of the fermentation products of the Lactobacillus used herein, or any mixture or combination thereof.

The systems can provide at least about 10³ CFU, alternatively from about 10³ to about 10¹⁴ CFU, alternatively from about 10⁶ to about 10¹² CFU, and alternatively from about from about 10⁸ to about 10¹¹ CFU of Lactobacillus, per day.

In one embodiment, the dosage units comprise a composition comprising a therapeutically effective amount a strain of Bifidobacterium, which can be mammalian. The mammal treated and a mammalian source of Bifidobacterium isolation may be, but need not be, independent.

Non-limiting examples of Bifidobacterium suitable for use herein include strains of Bifidobacterium longum, Bifidobacterium infantis, Bifidobacterium adolescentis, Bifidobacterium bifidum, Bifidobacterium animalis, Bifidobacterium pseudolongum, Bifidobacterium thermophilum, Bifidobacterium lactis, Bifidobacterium bulgaricus, Bifidobacterium breve, Bifidobacterium subtilis, and mixtures and/or combinations thereof.

In one embodiment herein, the dosage units can comprise at least about 10³ CFU, alternatively from about 10³ to about 10¹⁴ CFU, alternatively from about 10⁶ to about 10¹² CFU, and alternatively from about from about 10⁸ to about 10¹¹ CFU of Bifidobacterium, per dosage unit. The Bifidobacterium may be administered in either viable form, or as killed cells, or distillates, isolates or other fractions of the fermentation products of the Bifidobacterium used herein, or any mixture or combination thereof.

The systems can provide at least about 10³ CFU, alternatively from about 10³ to about 10¹⁴ CFU, alternatively from about 10⁶ to about 10¹² CFU, and alternatively from about from about 10⁸ to about 10¹¹ CFU of Bifidobacterium, per day.

As a portion of the compositions of the dosage units, the probiotic, as a freeze-dried powder (as would be understood by one of skill in the art) can comprise from about 1% to about 50%, alternatively from about 1% to about 40%, alternatively from about 1% to about 30%, and alternatively from about 2% to about 20%, by weight of the composition of the dosage unit.

### Fiber

The dosage units and systems of the present invention can also comprise fiber. Fiber can be useful in treating and/or preventing gastrointestinal conditions, as well as providing overall gastrointestinal health benefits. As used herein, the term “fiber” means carbohydrate polymers including those naturally occurring in food as consumed; those having been obtained from food raw material by physical, enzymatic or chemical means; and synthetic carbohydrate polymers, which are resistant to digestion and absorption in the small intestine and have partial fermentation in the large intestine.

Non-limiting examples of fibers and analogous carbohydrate polymers suitable for use in the present invention include pectins, psyllium, guar gum, xanthan gum, alginaes, gum arabic, fructo-oligosaccharides, inulin, agar, beta-glucans, chitins, dextrins, lignin, celluloses, non-starch polysaccharides, carrageenan, reduced starch, and mixtures and/or combinations thereof.

In one embodiment, the fiber is glucose polymers, preferably those which have branched chains. Among such suitable fibers is one marketed under the tradename “Fibersol2”, commercially available from Matsutani Chemical Industry Co., Itami City, Hyogo, Japan.

Other non-limiting examples of suitable fibers include oligosaccharides, such as inulin and its hydrolysis products commonly known as fructo-oligosaccharides, galacto-oligosaccharides, xylo-oligosaccharides, and oligo derivatives of starch.

The fiber can be provided in any suitable form. A non-limiting example is in the form of a plant material which contains the fiber. Non-limiting examples of suitable plant materials include asparagus, artichoke, onion, wheat, chicory, beet pulp, residues of these plant materials, and mixtures and/or combinations thereof.

A non-limiting example of a fiber from such a plant material is inulin extract from extract of chicory. Suitable inulin extracts can be obtained from Orafti SA of Belgium under the trademark Raftiline®. Alternatively the fiber can be in the form of a fructo-oligosaccharide which can be obtained from Orafti SA of Belgium under the trademark Raftilose®. Alternatively, an oliogo-saccharide can be obtained by hydrolyzing inulin, by enzymatic methods, or by using microorganisms as will be understood by those of skill in the art. Alternatively the fiber can be Inulin and/or de-sugared inulin available from Cargill Health & Food Technologies, Wayzata, Minn., USA, or from Cosucra SA, Warcoing, Belgium.

In another embodiment, the fiber can be psyllium, available, which can be obtained from The Procter & Gamble Company, Cincinnati, Ohio, under the trademark Metamucil®.

The fiber can be administered in a single daily dose or multiple daily doses.

The dosage units can comprise from about 10 mg to about 100 g, alternatively from about 50 mg to about 50 g, alternatively from about 100 mg to about 50 g, alternatively from about 500 mg to about 50 g, and alternatively from about 1 g to about 40 g of fiber, per dosage unit.

The systems can provide from about 10 mg to about 100 g, alternatively from about 50 mg to about 50 g, alternatively from about 100 mg to about 50 g, alternatively from about 500 mg to about 50 g, and alternatively from about 1 g to about 40 g of fiber, per day.

### Prebiotics

The dosage units and systems of the present invention can comprise a prebiotic. Prebiotics can be useful in treating and/or preventing gastrointestinal conditions, as well as providing overall gastrointestinal health benefits.

As used herein, the term “prebiotic” includes substances or compounds that beneficially affect the host mammal by selectively promoting the growth and/or activity of one or more probiotic bacteria in the gastro-intestinal tract of the host animal, thus maintaining normal health or improving health of the host. Typically, prebiotics are carbohydrates, (such as oligosaccharides), but the term “prebiotic” as used herein does not preclude non-carbohydrates. Many forms of “fiber” exhibit some level of prebiotic effect. Thus, there is considerable overlap between substances that can be classified as “prebiotics” and those that can be classified as “fibers”.

Non-limiting examples of prebiotics suitable for use in the compositions and methods include psyllium, fructo-oligosaccharides, inulin, oligofructose, galacto-oligosaccharides, isomalto-oligosaccharides, xylo-oligosaccharides, soy-oligosaccharides, gluco-oligosaccharides, mannan-oligosaccharides, arabinogalactan, arabinxylan, lactosucrose, gluconannan, lactulose, polydextrose, oligodextran, gentioligosaccharide, pectic oligosaccharide, xanthan gum, gum arabic, hemicellulose, resistant starch and its derivatives, reduced starch, and mixtures and/or combinations thereof.

The prebiotic can be administered in a single daily dose or multiple daily doses.

The dosage units can comprise from about 100 mg to about 100 g, alternatively from about 500 mg to about 50 g, and alternatively from about 1 g to about 40 g of prebiotic, per dosage unit.

The systems can provide from about 100 mg to about 100 g, alternatively from about 500 mg to about 50 g, and alternatively from about 1 g to about 40 g of prebiotic, per day.

### Polyphenols

The dosage units and systems of the present invention can comprise at least one polyphenol. Polyphenols are known to have antioxidant activity and anti-inflammatory effects and can thus be useful in treating and/or preventing respiratory and gastrointestinal conditions, as well as providing overall health benefits. Non-limiting examples of sources of polyphenols useful in the present invention include tea extract, rosemary extract, rosemarinic acid, coffee extract, caffeic acid, turmeric extract, blueberry extract, grape extract, grapeseed extract, soy extract, and mixtures and combinations thereof.

The dosage units can comprise from about 0.01% to about 90%, alternatively from about 0.1% to about 35%, alternatively from about 1% to about 15%, alternatively from about 1% to about 10%, and alternatively from about 3% to about 10% of the polyphenol, by weight of the composition of the dosage unit.

### Tea Extract

Non-limiting sources of tea extract for use in the present invention include black tea, white tea, oolong tea, and/or green tea.

When tea extract is present, the dosage units can comprise from about 0.01% to about 90%, alternatively from about 0.1% to about 35%, alternatively from about 1% to about 15%, alternatively from about 1% to about 10%, and alternatively from about 3% to about 10% tea extract, by weight of the composition of the dosage unit.

When tea extract is green tea, the dosage units can comprise from about 0.01% to about 90%, alternatively from about 0.1% to about 35%, alternatively from about 1% to about 15%, alternatively from about 1% to about 10%, and alternatively from about 3% to about 10% green tea extract, by weight of the composition of the dosage unit.

### Rosemary Extract

Constituents of rosemary or rosemary extract are caffeic acid and its derivatives such as rosemarinic acid. These compounds have antioxidant activity and anti-inflammatory effects. Non-limiting sources of rosemary extract suitable for use in the present invention include rosemary.

The dosage units can comprise from about 0.01% to about 90%, alternatively from about 0.1% to about 35%, alternatively from about 1% to about 15%, alternatively from about 1% to about 10%, and alternatively from about 3% to about 10% rosemary extract, by weight of the composition of the dosage unit.

The dosage units can comprise from about 0.01% to about 90%, alternatively from about 0.1% to about 35%, alternatively from about 1% to about 15%, alternatively from about 1% to about 10%, and alternatively from about 3% to about 10% rosemarinic acid, by weight of the composition of the dosage unit.

### Coffee Extract

The main constituent of coffee extract is caffeic acid and is, without being limited by theory, believed to display antioxidant activity.

The dosage units can comprise from about 0.01% to about 90%, alternatively from about 0.1% to about 35%, alternatively from about 1% to about 15%, alternatively from about 1% to about 10%, and alternatively from about 3% to about 10% coffee extract, by weight of the composition of the dosage unit.

When coffee extract is present, non-limiting sources of coffee extract include coffee bean, coffee, coffee berry, coffee fruits. When caffeic acid is present, non-limiting sources of caffeic acid suitable for use in the present invention include tea, berries, coffee bean, coffee, coffee berry, coffee fruits, rosemary extract, and/or grapeseed extract.

The dosage units can comprise from about 0.01% to about 90%, alternatively from about 0.1% to about 35%, alternatively from about 1% to about 15%, alternatively from about 1% to about 10%, and alternatively from about 3% to about 10% caffeic acid, by weight of the composition of the dosage unit.

### Turmeric Extract

Turmeric is a spice which comprises a main active compound that is curcumin. Curcumin is a bioactive polyphenol plant pigment. Without being limited by theory, it is believed that curcumin has antioxidant activity. A non-limiting source of turmeric extract for use in the present invention is tumeric.

The dosage units can comprise from about 0.01% to about 90%, alternatively from about 0.1% to about 35%, alternatively from about 1% to about 15%, alternatively from about 1% to about 10%, and alternatively from about 3% to about 10% turmeric extract, by weight of the composition of the dosage unit.

### Blueberry Extract

The dosage units and systems of the present invention can comprise blueberry extract. Blueberry extract is rich in anthocyanins which display antioxidant activity. A non-limiting source of blueberry extract for use in the present invention is blueberry.

The dosage unit can comprise from about 0.01% to about 90%, alternatively from about 0.1% to about 35%, alternatively from about 1% to about 15%, alternatively from about 1% to about 10%, and alternatively from about 3% to about 10% blueberry extract, by weight of the composition of the dosage unit.

### Grapeseed Extract

The dosage units and systems of the present invention can comprise grapeseed extract. Grape seed extract is rich in procyanidins which display antioxidant activity. Grapeseed extract comprises about 38.5% procyanindins. A non-limiting source of grapeseed extract for use in the present invention is grape seed.

The dosage units can comprise from about 0.01% to about 90%, alternatively from about 0.1% to about 35%, alternatively from about 1% to about 15%, alternatively from about 1% to about 10%, and alternatively from about 3% to about 10% grapeseed extract, by weight of the composition of the dosage unit.

### Grape Extract

The dosage units and systems of the present invention can comprise grape extract. Grape extract is rich in resveratrol which displays antioxidant activity. A non-limiting source of grape extract for use in the present invention is whole grapes.

The dosage units can comprise from about 0.01% to about 90%, alternatively from about 0.1% to about 35%, alternatively from about 1% to about 15%, alternatively from about 1% to about 10%, and alternatively from about 3% to about 10% grape extract, by weight of the composition of the dosage unit.

### Soy Extract

The dosage systems and units of the present invention can comprise soy extract. Soy extract is rich in isoflavonoids, such as genistein and diadzein, which display divers properties beneficial to health. A non-limiting source of soy extract for use in the present invention is soy.

The dosage units can comprise from about 0.01% to about 90%, alternatively from about 0.1% to about 35%, alternatively from about 1% to about 15%, alternatively from about 1% to about 10%, and alternatively from about 3% to about 10% soy extract, by weight of the composition of the dosage unit.

### Actives Particularly Useful for Animals

The dosage units and systems of the present invention can also comprise actives particularly useful for animals, non-limiting examples of which include dogs, cats, cows, rabbits and horses. Such actives can treat and/or prevent respiratory and/or gastrointestinal conditions as well as generally maintain and improve the overall health of the animal. While the types of actives described above can be used with both humans and other mammals, such as companion animals, the dosage units and systems of the present invention can also include actives particularly useful with non-human animals. In addition, although the actives described in this section are particularly useful with non-human animals, many of the actives described in this section are also suitable for use with humans.

Non-limiting examples of such actives include polyphosphates such as sodium hexametaphosphate (SHMP), sodium pyrophosphate, sodium tripolyphosphate, zinc chloride, copper gluconate, stannous chloride, stannous fluoride, sodium fluoride, triclosan; glucosamine hydrochloride, chondroitin sulfate, green lipped mussel, blue lipped mussel, methyl sulfonyl methane(MSM); boron, boric acid, phytoestrogens, phytoandrogens, genistein, diadzein, L-camitine, chromium picolinate, chromium tripicolinate, chromium nicotinate; glucose anti-metabolites which include 2-deoxy-D-glucose, 5-thio-D-glucose, 3-O-methylglucose, anhydrosugars including 1,5-anhydro-D-glucitol, 2,5-anhydro-D-glucitol, and 2,5-anhydro-D-mannitol, mannoheptulose, avocado extract comprising mannoheptulose; fiber; prebiotics including in particular fructooligosaccharides; acid/base modifiers, potassium citrate, potassium chloride, calcium carbonate, calcium chloride, sodium bisulfate; eucalyptus, lavender, peppermint, and combinations thereof.

The active can be administered in a single daily dose or multiple daily doses. The active can be incorporated into various types of dosage units, as described above. Non-limiting examples of dosage units that are particularly useful with animals are treats and biscuits.

The dosage units, i.e. each treat or biscuit, can comprise from about 0.0001 mg to about 10 g, alternatively from about 0.001 mg to about 10 g, alternatively from about 0.01 mg to about 10 mg, alternatively from about 1 mg to about 10 g, alternatively from about 10 mg to about 5 g, alternatively from about 30 mg to about 5 g, alternatively from about 30 mg to about 3 g, alternatively from about 300 mg to about 3 g, alternatively from about 300 mg to about 1.5 g of active, alternatively from about 30 mg to about 600 mg, and alternatively from about 30 mg to about 300 mg of active, per dosage unit.

The systems can provide from about 0.0001 mg to about 10 g, alternatively from about 0.001 mg to about 10 g, alternatively from about 0.01 mg to about 10 mg, alternatively from about 1 mg to about 10 g, alternatively from about 10 mg to about 5 g, alternatively from about 30 mg to about 5 g, alternatively from about 30 mg to about 3 g, alternatively from about 300 mg to about 3 g, alternatively from about 300 mg to about 1.5 g of active, alternatively from about 30 mg to about 600 mg, and alternatively from about 30 mg to about 300 mg of active, per day.

### Optional Materials

The dosage units and systems of the present invention can also comprise optional materials, non-limiting examples of which include amino-acids, fatty acids, carotenoids, anti-oxidants, and combinations thereof. The optional materials can be administered in a single daily dose or multiple daily doses.

### Amino Acids

When protein is broken down by digestion the result is 22 known amino acids. Eight are essential (cannot be manufactured by the body) the rest are non-essential (i.e. can be manufactured by the body with proper nutrition).

When an amino acid is present, the amino acid is selected from the group consisting of 1-Tryptophan, Taurine, Histidine, Carnosine, Alanine, Cysteine, and mixtures and/or combinations thereof.

The dosage units can comprise at least about 0.05%, alternatively from about 0.05% to about 10%, and alternatively from about 0.2% to about 5% of an amino acid, by weight of the composition of the dosage unit.

The dosage units can comprise from about 250 mg to about 2500 mg, alternatively from about 300 mg to about 2000 mg, and alternatively from about 400 mg to about 1000 mg of an amino acid, per dosage unit.

The systems can provide from about 250 mg to about 2500 mg, alternatively from about 300 mg to about 2000 mg, and alternatively from about 400 mg to about 1000 mg of an amino acid, per day.

### Carotenoids

A “carotenoid” is a class of pigments occurring in the tissues of higher plants, algae, bacteria and fungi. When a carotenoid is present, the carotenoid is selected from the group consisting of lutein, astaxanthin, zeaxanthin, bixin, lycopene, beta-carotene and mixtures and/or combinations thereof.

The dosage units can comprise at least about 0.01%, alternatively from about 0.01% to about 20%, and alternatively from about 0.05% to about 10% carotenoid, by weight of the composition of the dosage unit.

### Antioxidants

The dosage units and systems of the present invention can comprise an antioxidant in addition to the vitamins, plant-derived materials, elements, and carotenoids described above that have antioxidant properties. As used herein, an antioxidant is an enzyme or other organic molecule that can counteract the damaging effects of oxygen in tissues.

When an antioxidant is present, non-limiting examples of such antioxidants include tocopherols (Vitamin E, described above), Vitamin C (described above), Vitamin A (described above), plant-derived materials (described above), carotenoids (described above), selenium (described above), CoQ10, and mixtures and/or combinations thereof.

The dosage units and systems of the present invention can comprise coenzyme Q10 (CoQ10) The dosage units comprise at least about 0.01%, alternatively from about 0.01% to about 10%, and alternatively from about 0.2% to about 5% Coenzyme Q10, by weight of the composition of the dosage unit.

The dosage units can comprise from about 1 mg to about 400 mg, alternatively from about 2 mg to about 400 mg, and alternatively from about 3 mg to about 300 mg of Coenzyme Q10, per dosage unit.

The systems can provide from about 1 mg to about 400 mg, alternatively from about 2 mg to about 400 mg, and alternatively from about 3 mg to about 300 mg of Coenzyme Q10, per day.

### Fatty Acids

The dosage units and systems of the present invention can comprise a fatty acid. Long chain fatty acids play a key role in arachidonic acid metabolism which could be useful in the modulation of pain and inflammation. Currently, long chain fatty acids, such as omega-6 fatty acids are used for their antioxidant and immune health benefits.

Non-limiting examples of suitable long chain fatty acids include alpha-linoleic acid, gamma linolenic acid, linoleic acid, eicosapentanoic acid, and docosahexanoic acid. Fish oils are a suitable source of eicosapentanoic acids (EPA) and docosahexanoic acid (DHA).

The dosage units comprise from at least about 0.05%, alternatively at least about 0.1%, and alternatively at least about 0. 15% DHA, by weight of the composition of the dosage unit.

The dosage units can comprise from at least about 0.05%, alternatively at least about 0.1%, and alternatively at least about 0.15% EPA, by weight of the composition of the dosage unit.

### Excipients

The dosage units of the present invention can also comprise an excipient as would be understood by those of skill in the art with respect to production of various types of dosage units. Non-limiting examples of excipients include microcrystalline cellulose, dicalcium phosphate, stearic acid, magnesium stearate, corn starch, lactose, sodium crosscarmellose, sodium starch glycolate, polyvinylpyrollidone, gelatin, and combinations thereof.

The dosage units can comprise from about 1% to about 99%, alternatively from about 2% to about 70%, alternatively from about 3% to about 50%, alternatively from about 5% to about 30%, and alternatively from about 6% to about 25%, of the excipient, by weight of the composition of the dosage unit.

### Optional Ingredients

The dosage units of the present invention can also comprise one or more of a wide range of optional ingredients and process aids as would be understood by those of skill in the art with respect to production of various dosage forms. Non-limiting examples of optional ingredients include plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), anti-foaming agents (such as silicone), preservatives (such as butylated hydroxytoluene (BHT) and butylated hydroxyanisole (BHA), propyl gallate, benzalkonium chloride, EDTA, benzyl alcohol, potassium sorbate, parabens and mixtures thereof), reducing agents, solvents, hydrotropes, solublizing agents, suspending agents (non-surfactant), solvents, viscosity increasing agents (aqueous and non-aqueous), sequestrants, keratolytics, and the like, and mixtures and/or combinations thereof.

Generally, unless otherwise specified herein, the dosage units can comprise from about 0.001% to about 99%, alternatively from about 0.01% to about 80%, alternatively from about 0.01% to about 50%, and alternatively from about 0.01% to about 10%, of optional ingredient(s) by weight of the composition of the dosage unit.

### Method of Using

The methods of the present invention comprise orally administering (i.e., through ingestion) and/or topically administering (i.e. via a lotion) one or more dosage units of the present invention to a mammal to treat a condition or provide a desired benefit. Non-limiting examples of mammals include humans (infant through adult), and domestic and companion animals such as cats, dogs, cows, rabbits, and horses. In one embodiment, the mammal is a human. In another embodiment, the mammal is a dog or cat.

As used herein, the term “orally administering” with respect to the mammal means that the mammal ingests or a human is directed to administer, or does administer, to oneself (or another human or other mammal) one or more of the dosage units described herein. Wherein the human is directed to administer the dosage unit, such direction can be indicia which instructs and/or informs the human that use of the active contained in the dosage unit can and/or will provide the referenced benefit, for example, alleviation of one or more symptoms associated with the common cold or influenza, alleviation of one or more symptoms associated with a gastrointestinal condition, or providing a health benefit.

Direction to administer one or more dosage units (orally and/or topically) can be oral direction (e.g., through oral instruction from, for example, a physician, pharmacist, nurse, veterinarian or other health professional), radio or television media (i.e., advertisement), or written direction (e.g., through written direction from, for example, a veterinarian or other health professional (e.g., scripts), sales professional or organization (e.g., through, for example, marketing brochures, pamphlets, or other instructive paraphernalia), written media (e.g., Internet, electronic mail, or other computer-related media)), and/or packaging associated with the dosage unit (e.g., the previously described indicia present on a container containing the dosage units). As used herein, “written” means through words, pictures, symbols, and/or other visible descriptors. Such direction and/or indicia need not utilize specific words used herein, for example, “respiratory”, “gastrointestinal”, “mammal”, “human”, or “treatment”, but rather use of words, pictures, symbols, and the like conveying the same or similar meaning are contemplated for the direction and indicia within the scope of this invention.

The dosage units described herein can be orally administered in any convenient form, non-limiting examples of which include, for example, a tablet, dragee, capsule, caplet, including enteric coated and sustained-release forms, suspension, confectionary such as a gum or soft ‘gummie’, chewable tablet, dissolvable film, liquid-filled capsule, powder, syrup, elixir, liquid, suppository, treat, biscuit, and combinations thereof. The dosage units described herein can also be topically administered in any convenient form, non-limiting examples of which include, for example, lotions, creams, patches, inhaled compositions such as in a nasal spray or mist, and combinations thereof.

The actives of the dosage units described herein can be used to prevent a condition, treat a condition, and/or as a supplement to ordinary diet to provide and/or improve and/or maintain health and well-being.

Administration of the dosage units of the present invention can be on an as-needed or as-desired basis, for example, once-monthly, once-weekly, or daily (including multiple times daily, to arrive at a total daily dose or amount of a given component), or as-needed for the duration of a condition, such as for example a cold. When utilized as a supplement to ordinary diet for health and well-being, the dosage unit can be administered directly to the mammal (e.g., a capsule or tablet) or otherwise contacted with or admixed with food (e.g. powder mixed with yogurt, juice, milk or pet food).

The amount of a given active and/or number of dosage units of a given active utilized by a mammal can be dependent on a variety of factors, including the type of mammal, health status, age, gender, severity of symptoms, or other like factors of ordinary consideration.

The systems of the present invention can comprise various numbers of dosage units depending on the desired and/or preferred amounts and duration of use. For example cold and flu systems can be provided with between about 2 and about 20 dosage units, which would provide enough dosage units to last a user through the typical 3 to 10 day period of the common cold.

Alternatively, gastrointestinal systems can provide an amount of dosage units suitable for a 1 to 2 day duration of gastrointestinal upset, or can provide enough dosage units for one or two weeks, or a month, such as to last a user through a period of travel of up to a month.

Systems for overall wellness can also be provided with various numbers of dosage units depending on the frequency and duration of use of the actives contained in the dosage units of the system. For example, joint health systems could be provided with sufficient dosage units for one month of use.

Respiratory health systems can be provided with sufficient dosage units for two weeks, for example to last during travel; or for a season, for example a three-month system to last the majority of a winter and/or cold and flu season.

To select an appropriate system, the user uses the indicia on the primary and/or secondary container, and/or at the point of purchase, to determine the appropriate system containing the appropriate actives and the appropriate duration of use. The indicia can be viewed, touched, heard, smelled, and/or provided by and/or in a machine-readable form. The user is then able to select one or more appropriate systems and customize the dosing of the actives as needed or desired based on how the user feels, what benefits the user desires and/or what symptoms a user wishes to treat, whether in the user or another mammal such as a child or animal.

### Kits

The systems and dosage units of the present invention can also be included as part of a kit containing products complimentary to the system and dosage units, and/or medical devices that contain products complimentary to the system and dosage units, and/or medical devices that can enhance and/or compliment one or more actives of a system. A non-limiting example of kits containing a system of the present invention and complimentary products includes a system for treatment of a respiratory condition, including a plurality of groups of dosage units, each group of dosage units comprising a different respiratory active, in combination with a container of hand sanitizer, a container of nasal spray and/or a container of antiviral and/or conventional tissues.

An additional non-limiting example of such kits includes a system for treatment of a gastrointestinal condition in combination with a container of rehydrating drink containing electrolytes (for example from about 0.1% to about 10%, alternatively about 0.5% sodium chloride, % wt/volume of the drink composition) and carbohydrates (for example from about 1 to about 20%, alternatively about 10% sucrose, % wt/volume of the drink composition). Non-limiting examples of such types of rehydrating drinks include drinks known by the names Gatorade®, Powerade®, Propel® fitness water, and Pedialyte®.

An additional non-limiting example of such kits includes a system for treatment of menstrual symptoms comprising a pain active, a diuretic and a stimulant in combination with one or more herbal teas.

An additional non-limiting example of such kits includes a system for animal health comprising actives for gastrointestinal health, joint health and longevity in combination with toys for exercise and mental stimulation.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. All exemplified concentrations are weight-weight percents, unless otherwise specified.

### Example #1

A system comprising a blister pack that contains tablets with individual actives that can be taken separately or together to treat respiratory symptoms related to cold/cough/flu is provided. The system allows a user to customize treatment of symptoms as needed.

Each group of tablets in the blister pack contains the following:
1 tablet that contains 20 mg Dextromethorphan HBr
1 tablet that contains 10 mg Phenylephrine HCl
1 tablet that contains 500 mg Acetaminophen
1 tablet that contains 12.5 mg Doxlyamine succinate.

A color and/or other instructive indicia can be associated with each tablet and each active.

### Example #2

A system comprising a blister pack that contains tablets with individual actives that can be taken separately or together to treat respiratory symptoms related to cold/cough/flu is provided. The system allows a user to customize treatment of symptoms as needed.

Each group of tablets in the blister pack contains the following:
1 tablet that contains 20 mg Dextromethorphan HBr and 200 mg Guaifenesin
1 tablet that contains 10 mg Phenylephrine HCl
1 tablet that contains 500 mg Acetaminophen
1 tablet that contains 12.5 mg Doxlyamine succinate.

A color and/or other instructive indicia can be associated with each tablet and each active.

### Example #3

A system comprising a blister pack that contains tablets with individual actives that can be taken separately or together to treat respiratory symptoms related to cold/cough/flu is provided. The system allows a user to customize treatment of symptoms as needed.

Each group of tablets in the blister pack contains the following:
1 tablet that contains 20 mg Dextromethorphan HBr
1 tablet that contains 10 mg Phenylephrine HCl
1 tablet that contains 500 mg Acetaminophen
1 tablet that contains 200 mg Guaifenesin.

A color and/or other instructive indicia can be associated with each tablet and each active.

### Example #4

A system comprising a blister pack that contains tablets with individual actives that can be taken separately or together to treat respiratory symptoms related to cold/cough/flu is provided. The system allows a user to customize treatment of symptoms as needed.

Each group of tablets in the blister pack contains the following:
1 tablet that contains 30 mg Dextromethorphan HBr
1 tablet that contains 60 mg Pseudoephedrine HCl
1 tablet that contains 1000 mg Acetaminophen
1 tablet that contains 12.5 mg Doxlyamine succinate.

A color and/or other instructive indicia can be associated with each tablet and each active.

### Example #5

A system comprising a blister pack that contains tablets with individual actives that can be taken separately or together to treat respiratory symptoms related to allergy/sinus symptoms is provided. The system allows a user to customize treatment of symptoms as needed.

Each group of tablets in the blister pack contains the following:
1 tablet that contains 10 mg Phenylephrine
1 tablet that contains 650 mg Acetaminophen
1 tablet that contains 12.5 mg Doxlyamine succinate.

A color and/or other instructive indicia can be associated with each tablet and each active.

### Example #6

A system comprising a blister pack that contains tablets with individual actives that can be taken separately or together to treat respiratory symptoms is provided. The system allows a user to customize treatment of symptoms as needed.

Each group of tablets in the blister pack contains the following:
2 softgel capsules that each contains 5 mg Phenylephrine, 10 mg Dextromethorphan HBr, 352 mg Acetaminophen
1 lozenge that contains 10 mg Menthol, 10 mg Benzocaine
2 softgel capsules that each contains 5 mg Phenylephrine, 15 mg Dextromethorphan HBr, 325 mg Acetaminophen.

A color and/or other instructive indicia can be associated with each dosage unit and each active.

### Example #7

A system comprising a container that stores individual unit doses of liquid formulas with individual actives that can be taken separately or together to treat respiratory symptoms is provided.

Each group of liquid formulas in the blister pack contains the following:
1 unit dose of liquid that contains 10 mg Phenylephrine
1 unit dose of liquid that contains 15 mg Dextromethorphan
1 unit dose of liquid that contains 2 mg Chlorpheniramine maleate.

A color and/or other instructive indicia can be associated with each liquid and each active.

### Example #8

A system comprising a blister pack containing solid dose forms that contain individual actives that can be taken separately or together to help treat and/or prevent cold symptoms is provided. The system allows a user to customize treatment as desired.

Each group of solid dose forms in the blister pack contains the following:
1 orally dissolvable drop that contains 60 mg Ascorbic Acid
1 tablet that contains 20 mg andrographolides from Andrographis paniculata and 0.10 mg Eleutherococcus senticosus extract and
1 tablet that contains 12.5 μg Cholecalfierol (Vitamin D3).

A color and/or other instructive indicia can be associated with each solid dose form and each active.

### Example #9

A system comprising a blister pack that contains tablets with individual actives that can be taken separately or together to help treat and/or prevent symptoms related to cough/cold/flu, and aid in overall wellness is provided. A user can customize treatment based on the type and/or severity of symptoms.

Each group of tablets in the blister pack contains the following:
2 tablets that each contain 20 mg andrographolides from Andrographis paniculata
1 tablet that contains 60 mg Ascorbic Acid
1 lozenge that contains 13.3 mg Zinc

A color and/or other instructive indicia can be associated with each tablet or lozenge and each active.

### Example #10

A system comprising a blister pack that contains tablets with individual actives that can be taken separately or together to help treat and/or prevent symptoms related to colds and flu is provided. A user can customize treatment based on the type and/or severity of symptoms.

Each group of tablets in the blister pack contains the following:
1 tablet that contains 20 mg Dextromethorphan HBr
1 tablet that contains 10 mg Phenylephrine HCl
1 tablet that contains 650 mg Acetaminophen
1 tablet that contains 12.5 mg Doxylamine succinate
1 tablet that contains 50 μg Cholecalciferol.

A color and/or other instructive indicia can be associated with each tablet and each active.

### Example #11

A system comprising a blister pack that contains tablets with individual actives that can be taken separately or together to help treat and/or prevent symptoms related to colds and flu is provided. A user can customize treatment based on the type and/or severity of symptoms.

Each group of tablets in the blister pack contains the following:
1 tablet that contains 20 mg Dextromethorphan HBr
1 tablet that contains 10 mg Phenylephrine HCl
1 tablet that contains 650 mg Acetaminophen
1 tablet that contains 12.5 mg Doxylamine succinate
1 tablet that contains 360 mg Rhodiola.

A color and/or other instructive indicia can be associated with each tablet and each active.

### Example #12

A system comprising a blister pack that contains tablets with individual actives that can be taken separately or together to help treat and/or prevent symptoms related to colds and flu is provided. A user can customize treatment based on the type and/or severity of symptoms.

Each group of tablets in the blister pack contains the following:
1 tablet that contains 50 μg Cholecalciferol
1 tablet that contains 100 mg Ascorbic acid
1 lozenge that contains 13.3 mg of Zinc
1 tablet that contains 360 mg Rhodiola.

A color and/or other instructive indicia can be associated with each tablet and each active.

### Example #13

A system comprising a blister pack that contains tablets with individual non-prescription actives that can be taken separately or together in combination with a prescription active to help treat and/or prevent symptoms related to colds, flu, and/or bacterial respiratory conditions is provided. A user can customize treatment based on the type and/or severity of symptoms.

Each group of tablets in the blister pack contains the following:
1 tablet that contains 500 mg Amoxicillin
1 tablet that contains 60 mg Ascorbic acid
1 tablet that contains 200 mg Ibuprofen.

A color and/or other instructive indicia can be associated with each tablet and each active

### Example #14

A kit comprising a blister pack that contains tablets with individual actives that can be taken separately or together to help treat and/or prevent symptoms related to colds and flu, and complimentary products, is provided. A user can customize treatment based on the type and/or severity of symptoms.

Each group of tablets in the blister pack contains the following:
1 tablet that contains 20 mg Dextromethorphan HBr
1 tablet that contains 10 mg Phenylephrine HCl
1 tablet that contains 650 mg Acetaminophen
1 tablet that contains 12.5 mg Doxylamine succinate
1 tablet that contains 50 μg Cholecalciferol.

A color and/or other instructive indicia can be associated with each tablet and each active.

Also included in the kit are:
A nasal spray containing 0.05% Oxymetazoline
A container of hand sanitizing lotion
A package of antiviral tissues.

### Example #15

A system comprising a blister pack that contains tablets with individual actives that can be taken separately or together to treat symptoms related to heartburn, sour stomach, and/or acid indigestion is provided. A user can customize treatment based on the type and/or severity of symptoms.

Each group of tablets in the blister pack contains the following:
2 tablets that each contain 262 mg Bismuth Subsalicylate
1 tablet that contains 1000 mg Calcium Carbonate
1 tablet that contains 10 mg Famotidine.

A color and/or other instructive indicia can be associated with each tablet and each active.

### Example #16

A system comprising a blister pack that contains tablets with individual actives that can be taken separately or together to help treat and/or prevent symptoms related to heartburn, diarrhea, constipation, gas, and/or bloating is provided. A user can customize treatment based on the type and/or severity of symptoms.

Each group of tablets in the blister pack contains the following:
2 tablets that each contain at least 1×10⁸ cfu of Lactobacillus acidophilus
1 chewable tablet that contains 2 g Inulin
1 tablet that contains 250 mg Psyllium.

A color and/or other instructive indicia can be associated with each tablet and each active.

### Example #17

A kit comprising a blister pack that contains tablets with individual actives that can be taken separately or together to help treat and/or prevent symptoms related gastrointestinal conditions, for example diarrhea, and a complimentary product, is provided. A user can customize treatment based on the prevalence and/or severity of symptoms.

Each group of tablets in the blister pack contains the following:
1 tablet that contains 262 mg Bismuth subsalicylate
1 tablet that contains 250 mg Psyllium
1 tablet that contains 650 mg Acetaminophen.

A color and/or other instructive indicia can be associated with each tablet and each active.

Also provided in the kit is a container containing ½ L of a rehydration drink comprising a flavored aqueous solution containing 0.5% sodium chloride and 10% sucrose (% wt/volume).

### Example #18

A system comprising a blister pack that contains tablets with an individual non-prescription active that can be taken separately or together in combination with a prescription active to help treat and/or prevent symptoms related to gastrointestinal conditions is provided. A user can customize treatment based on the type and/or severity of symptoms.

Each group of tablets in the blister pack contains the following:
2 tablets that each contain at least 1×10⁸ cfu of Bifidobacterium infantis
6 tablets that each contain 400 mg mesalamine.

A color and/or other instructive indicia can be associated with each tablet and each active.

### Example #19

A kit comprising a blister pack that contains tablets with individual actives that can be taken separately or together to build or maintain overall health and well-being is provided, along with complimentary products. A user can customize dosing based on desired benefits.

Each group of tablets in the blister pack contains the following:
1 tablet that contains at least 1×10⁸ cfu of Bifidobacterium infantis
1 tablet that contains 60 mg Ascorbic Acid
2 chewable tablets that contain 1000 mg Calcium Carbonate.

Also provided in the kit are:
7 stick packs each containing 2 g Inulin.

A color and/or other instructive indicia can be associated with each tablet and each active.

### Example #20

A kit comprising a blister pack that contains tablets with individual actives that can be taken separately or together to help treat and/or prevent symptoms related to the menstrual cycle is provided, along with complimentary products. A user can customize treatment based on the time of day and type and/or severity of symptoms.

Each group of tablets in the blister pack contains the following:
1 tablet containing 200 mg Ibuprofen
1 tablet containing 50 mg Caffeine.

A color and/or other instructive indicia can be associated with each tablet and each active.

Also provided in the kit are:
6 teabags containing green tea to be brewed as an infusion (can be taken instead of or in addition to a caffeine tablet)
6 teabags containing a chamomile to be brewed as an infusion (used for relaxation and calming).

### Example #21

A system comprising a blister pack that contains a group of treats with individual actives that can be taken separately or together to help treat and/or prevent gastrointestinal upsets is provided. The treats are for consumption by a companion animal, such as a dog, cat or horse.

Each group of treats in the blister pack contains the following:
1 treat that contains 5×10⁹ dose of Lactobacillus acidophilus
1 treat that contains 500 mg of fructooligosaccharides.

A color and/or other instructive indicia can be associated with each treat and each active.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A customizable dosing system comprising:
a primary container comprising at least one enclosure, said enclosure containing a dosage unit comprising an active; and
indicia for selection or deselection of said system and said dosage unit and active; wherein said indicia enables a user to select a said system, a said dosage unit and a said active appropriate to a user's needs.

2. The dosing system of claim 1 wherein said active is selected from the group consisting of actives to treat and/or prevent respiratory conditions; actives to treat and/or prevent gastrointestinal conditions; actives to provide a health benefit; and combinations thereof.

3. The dosing system of claim 2 wherein said active is selected from the group consisting of decongestants, anti-cholinergics, expectorants, antihistamines, antitussives, analgesics, anti-virals, mucolytics, demulcents, anesthetics, antibiotics; laxatives, anti-diarrheals; anti-emetics; anti-inflammatories; antacids; anti-flattulents; vitamins; minerals; metals; elements; plant-derived materials; energy-boosting materials; probiotics; fiber; prebiotics; and combinations thereof.

4. The dosing system of claim 3 wherein said primary container comprises a plurality of said dosage units, each said dosage unit comprising an active to treat and/or prevent a respiratory condition.

5. The dosing system of claim 4 wherein said active to treat and/or prevent a respiratory condition is selected from the group consisting of decongestants, anti-cholinergics, expectorants, antihistamines, antitussives, analgesics, anti-virals, mucolytics, demulcents, anesthetics, antibiotics; vitamins; minerals; metals; elements; plant-derived materials; energy-boosting materials; probiotics; fiber; prebiotics; and combinations thereof.

6. The dosing system of claim 3 wherein said primary container comprises a plurality of groups of said dosage units, each said group of said dosage units comprising a different active to treat a different respiratory symptom.

7. The dosing system of claim 3 wherein said primary container comprises a plurality of said dosage units, each said dosage unit comprising an active to treat and/or prevent a gastrointestinal condition.

8. The dosing system of claim 7 wherein said active to treat and/or prevent a gastrointestinal condition is selected from the group consisting of laxatives, anti-diarrheals; anti-emetics; anti-inflammatories; antacids; anti-flattulents; vitamins; minerals; metals; elements; plant-derived materials; energy-boosting materials; probiotics; fiber; prebiotics; and combinations thereof.

9. The dosing system of claim 3 wherein said primary container comprises a plurality of groups of said dosage units, each said group of said dosage units comprising a different active to treat a different gastrointestinal symptom.

10. The dosing system of claim 3 wherein said primary container comprises a plurality of said dosage units, each said dosage unit comprising an active to provide a health benefit.

11. The dosing system of claim 10 wherein said active to provide a health benefit is selected from the group consisting of vitamins; minerals; metals; elements; plant-derived materials; energy-boosting materials; probiotics; fiber; prebiotics; and combinations thereof.

12. The dosing system of claim 3 wherein said primary container comprises a plurality of groups of said dosage units, each said group of said dosage units comprising a different active to provide a different health benefit.

13. The dosing system of claim 3 wherein said vitamins are selected from the group consisting of Vitamin A, Vitamin B1, Vitamin B2, Vitamin B3, Vitamin B5, Vitamin B6, Vitamin B7, Vitamin B9, Vitamin B12, Vitamin C, Vitamin D2, Vitamin D3, Vitamin E, and combinations thereof.

14. The dosing system of claim 3 wherein said minerals are selected from the group consisting of zinc, iron, calcium, iodine, copper, selenium, salts thereof, and combinations thereof.

15. The dosing system of claim 3 wherein said plant-derived materials selected from the group consisting of polyphenols, green tea, black tea, white tea, rosemary, coffee, turmeric, blueberry, grapeseed, Andrographis paniculata, Allium sativum, Eleutherococcus senticosus, a guaiacol component, ginger, and combinations thereof.

16. The dosing system of claim 3 wherein said energy-boosting materials are selected from the group consisting of caffeine, Vitamin B complex, green tea, taurine, Rhodiola rosea, Eleutherococcus senticosus, Vitamin C, iron, CoQ10, L-carnitine, L-Theanine, Vitamin D, guarana, magnesium, Schizandra chinensis, Yerba Mata, Goji, quercetin, amalaki, acai, maca, ginkgo biloba, glucuronolactone, panax ginseng, Echinacea, rooibos, DHEA, aromas and aromatherapy, noni, mangosteen, and selenium, and combinations thereof.

17. The dosing system of claim 3 wherein said probiotic is selected from the group consisting of Streptococcus lactis, Streptococcus cremoris, Streptococcus diace ylactis, Streptococcus thermophilus, Lactobacillus bulgaricus, Lactobacillus acidophilus, Lactobacillus helveticus, Lactobacillus bifidus, Lactobacillus casei, Lactobacillus lactis, Lactobacillus plantarum, Lactobacillus rhamnosus, Lactobacillus delbruekii, Lactobacillus thermophilus, Lactobacillus fermentii, Lactobacillus salivarius, Lactobacillus reuteri, Lactobacillus brevis, Lactobacillus paracasei, Lactobacillus gasseri, Pediococcus cerevisiae, Bifidobacterium longum, Bifidobacterium infantis, Bifidobacterium adolescentis, Bifidobacterium bifidum, Bifidobacterium animalis, Bifidobacterium pseudolongum, Bifidobacterium thermophilum, Bifidobacterium lactis, Bifidobacterium bulgaricus, Bifidobacterium breve, Bifidobacterium subtilis, Escherichia coli, strains of the genera Bacillus, Bacteroides, Enterococcus (e.g., Enterococcus faecium) and Leuconostoc, and combinations thereof.

18. The dosing system of claim 3 wherein said fiber is selected from the group consisting of pectins, psyllium, guar gum, xanthan gum, alginaes, gum arabic, fructo-oligosaccharides, inulin, agar, beta-glucans, chitins, dextrins, lignin, celluloses, non-starch polysaccharides, carrageenan, reduced starch, and combinations thereof.

19. The dosing system of claim 3 wherein said prebiotic is selected from the group consisting of psyllium, fructo-oligosaccharides, inulin, oligofructose, galacto-oligosaccharides, isomalto-oligosaccharides, xylo-oligosaccharides, soy-oligosaccharides, gluco-oligosaccharides, mannan-oligosaccharides, arabinogalactan, arabinxylan, lactosucrose, gluconannan, lactulose, polydextrose, oligodextran, gentioligosaccharide, pectic oligosaccharide, xanthan gum, gum arabic, hemicellulose, resistant starch and its derivatives, reduced starch, and combinations thereof.

20. The dosing system of claim 1 wherein said indicia is selected from the group consisting of alphanumeric indicia, pictorial indicia, color indicia, sound indicia, texture indicia, size indicia, shape indicia, symbolic indicia, aural indicia, machine-readable indicia, machine-generated indicia, and combinations thereof.

21. The dosing system of claim 1 wherein each said dosage unit and each said active is associated with corresponding said indicia.

22. The dosing system of claim 1 wherein said primary container is selected from the group consisting of a blister pack, blister card, blister sheet, and combinations thereof.

23. The dosing system of claim 1 further comprising a means for removing a portion of said primary container.

24. The dosing system of claim 1 further comprising a secondary container.

25. The dosing system of claim 24 wherein said secondary container encloses said primary container.

26. The dosing system of claim 24 wherein said primary container is removably contained within said secondary container.

27. The dosing system of claim 24 wherein said secondary container and said primary container are fixedly attached each to the other to form an integrated structure.

28. The dosing system of claim 2 further comprising a plurality of said primary containers.

29. The dosing system of claim 28 comprising a secondary container, wherein said secondary container encloses said plurality of said primary containers.

30. The dosing system of claim 28 wherein each of said plurality of said primary containers comprises dosage units comprising an active to treat and/or prevent a respiratory condition.

31. The dosing system of claim 30 wherein each of said plurality of said primary containers comprises dosage units comprising a different active to treat a different respiratory symptom.

32. The dosing system of claim 28 wherein each of said plurality of said primary containers comprises dosage units comprising an active to treat and/or prevent a gastrointestinal condition.

33. The dosing system of claim 32 wherein each of said plurality of said primary containers comprises dosage units comprising a different active to treat a different gastrointestinal symptom.

34. The dosing system of claim 28 wherein each of said plurality of said primary containers comprises dosage units comprising an active to provide a health benefit.

35. The dosing system of claim 34 wherein each of said plurality of said primary containers comprises dosage units comprising a different active to provide a different health benefit.

36. The dosing system of claim 1 wherein said dosage unit is selected from the group consisting of tablets; dragees; caplets; gel caps; solid-filled capsules; liquid-filled capsules; enteric-coated forms; sustained-release forms; solid lozenges; liquid-filled lozenges; mouth and throat drops; gum; confectionaries; “gummies”; effervescent tablets; dry dissolvable powders; dissolvable film strips; syrups; elixirs; liquids; suppositories; sublingual tablets; buccal tablets; patches for transdermal delivery of actives; drinks; food products, treats, biscuits; topical compositions that release agents that are absorbed into and through the skin and/or mucus membranes; inhalants; topical compositions that release volatile agents that are inhaled through the nose into the respiratory tract; and combinations thereof.

37. The dosing system of claim 1 wherein said dosage unit comprises two or more actives.

38. A method of providing user-customizable dosing comprising:
a) providing a primary container comprising at least one enclosure, said enclosure containing a dosage unit comprising an active;
b) providing indicia for selection or deselection of said dosage unit and active; and
c) via said indicia enabling a user to select and administer said dosage unit and said active appropriate to said user's needs.

39. The method of claim 38 further comprising providing a plurality of said dosage units, each said dosage unit comprising an active selected from the group consisting of actives to treat and/or prevent a respiratory condition; actives to treat and/or prevent a gastrointestinal condition; actives to provide a health benefit; and combinations thereof.

40. The method of claim 39 wherein each said dosage unit comprises an active to treat a respiratory condition.

41. The method of claim 40 further comprising providing a plurality of groups of said dosage units, each group of said dosage units comprising a different active to treat a different respiratory symptom.

42. The method of claim 39 wherein each said dosage unit comprises an active to treat a gastrointestinal condition.

43. The method of claim 42 further comprising providing a plurality of groups of said dosage units, each group of said dosage units comprising a different active to treat a different gastrointestinal symptom.

44. The method of claim 39 wherein each said dosage unit comprises an active to provide a health benefit.

45. The method of claim 44 further comprising providing a plurality of groups of said dosage units, each group of said dosage units comprising a different active to provide a different health benefit.

46. The method of claim 38 further comprising providing a secondary container which contains said primary container.

47. The method of claim 38 further comprising a plurality of primary containers, each said primary container comprising a plurality of said dosage units.

48. The method of claim 47 wherein each said plurality of dosage units comprises an active selected from the group consisting of actives to treat and/or prevent a respiratory condition; actives to treat and/or prevent a gastrointestinal condition; actives to provide a health benefit; and combinations thereof.

49. The method of claim 48, wherein each said primary container, and said dosage units contained therein, comprises a different active to treat a different respiratory symptom.

50. The method of claim 48, wherein each said primary container, and said dosage units contained therein, comprises a different active to treat a different gastrointestinal symptom.

51. The method of claim 48, wherein each said primary container, and said dosage units contained therein, comprises a different active to provide a health benefit.

52. The method of claim 38 comprising the step of administering said active at least once weekly.

53. The method of claim 38 comprising the step of administering said active at least once daily.

54. A kit for customizing treatment comprising:
A customizable dosing system comprising
a) a primary container comprising at least one enclosure, said enclosure containing a dosage unit comprising an active; and
b) indicia for selection or deselection of said kit said dosage unit and said active; wherein said indicia enables a user to select a system, a said dosage unit and a said active appropriate to a user's needs; and
A product complimentary to said system.
